(19) United States
(12) Patent Application Publication
(10) Pub. No.: US 2024/0174840 A1
(43) Pub. Date: May 30, 2024

(54) USE OF A STABILIZER COMPOSITION FOR STABILIZING ORGANIC MATERIALS, STABILIZER COMPOSITION, MASTER BATCH, COMPOSITION, MOLDING COMPOUND FOR MOLDINGS, PROCESS FOR OXIDATIVE, THERMAL AND ACTINIC STABILIZATION OF A THERMOPLASTIC, AND USE OF A COMPOSITION

(71) Applicant: FRAUNHOFER-GESELLSCHAFT ZUR FÖRDERUNG DER ANGEWANDTEN FORSCHUNG E.V., München (DE)

(72) Inventors: Rudolf PFAENDNER, Darmstadt (DE); Matthias POLIDAR, Darmstadt (DE); Elke METSCH-ZILLIGEN, Darmstadt (DE)

(73) Assignee: FRAUNHOFER-GESELLSCHAFT ZUR FÖRDERUNG DER ANGEWANDTEN FORSCHUNG E.V., München (DE)

(21) Appl. No.: 18/548,504

(22) PCT Filed: Mar. 1, 2022
(86) PCT No.: PCT/EP2022/055094

§ 371 Date: Aug. 31, 2023

(30) Foreign Application Priority Data
Mar. 4, 2021 (DE) 10 2021 202 102.6

(51) Int. Cl. C08K 13/02; C08L 67/04

(52) U.S. Cl. CPC C08K 13/02; C08L 67/04; C08K 5/34926

(57) ABSTRACT

The present invention relates to the combined use of sulfite and/or at least one thiosulfate and a polymeric or oligomeric hindered amine for stabilizing organic materials, in particular against oxidative thermal and/or actinic degradation. The present invention further relates to correspondingly produced compositions, to moldings producible from these compositions, to a method for stabilizing organic materials and to possible uses of the stabilized organic materials.

The present invention relates to the combined use of sulfite and/or at least one thiosulfate and also a polymeric or oligomeric hindered amine for stabilizing organic materials, in particular against oxidative thermal and/or actinic degradation. Furthermore, the present invention relates to correspondingly prepared compositions, molded parts producible therefrom, a method for stabilizing organic materials and possible uses of the stabilized organic materials.

Organic materials such as plastics are subject to aging processes that ultimately lead to a loss of the desired properties, such as the mechanical characteristic values. This process, called autoxidation, leads to changes in the polymer chain, such as in the molecular weight or the formation of new chemical groups, starting from radical chain cleavages by mechanochemical processes or by UV radiation in the presence of oxygen. Stabilizers are therefore used to prevent or at least delay this aging. Important representatives of stabilizers are antioxidants that interfere with the radicals formed during autoxidation and thus interrupt the degradation process. A distinction is generally made between primary antioxidants, which can react directly with oxygen-comprising free radicals or C radicals, and secondary antioxidants, which react with intermediately formed hydroperoxides (see C. Kröhnke et al. Antioxidants in Ullmann's encyclopedia of industrial chemistry, Wiley-VCH Verlag, Weinheim 2015,). Typical representatives of primary antioxidants are, for example, phenolic antioxidants, amines, but also lactones. Classes of secondary antioxidants are phosphorus compounds such as phosphites or phosphonites, but also organo-sulfur compounds such as sulfides or disulfides. Typically, primary and secondary antioxidants are often combined in practice, resulting in a beneficial synergistic effect.

Combinations of hindered amines with sulfites as stabilizers for plastics and for plastic recyclates are not yet known. Since some of the stabilizers used today can also have disadvantages (e.g. hydrolysis stability of phosphites and release of phenol, hydrolysis stability of phenolic antioxidants and release of phenol or of degradation products, odor in the case of sulfide stabilizers, discoloration in the case of phenols or amines, etc.), new stabilizer solutions are still sought, including the desire for stabilizer solutions that do not comprise a phenolic antioxidant and/or that are free of phenols.

Phenol-free stabilizer solutions for plastics are known in principle and usually consist of a combination of hindered amines (HAS=hindered amine stabilizers) with processing stabilizers such as lactones, phosphites or hydroxylamines. These systems are described for example in WO 2000020209 or WO 2002095095 for fiber fabrics or in US 20020086924 or US 20030195282 for gamma-irradiated polyolefin applications.

Only CN 101323956 claims an anti-corrosion masterbatch comprising UV stabilizers as an option and calcium sulfite as a UV absorber; CN 106047284 mentions an anti-electrostatic, thermally conductive adhesive for LED lamps comprising 10-20 parts unspecified sulfite and hindered amines.

No conclusion can be drawn from the prior art for a stabilizing effect of a combination of hindered amines and inorganic sulfites.

Combinations of hindered amines with sulfites as stabilizers for plastics and for plastic recyclates are not yet known.

Against the background described above, it is therefore the object of the present invention to provide new stabilizers or methods or uses for stabilizing organic materials, in particular plastics, which are highly effective, environmentally friendly and have a favorable cost structure.

This object is achieved with the features of the independent claims. The dependent claims relate to advantageous developments.

In a first aspect, the present invention thus relates to the use of at least one stabilizer composition comprising or consisting of at least one sulfite and/or at least one thiosulfate in combination with at least one polymeric or oligomeric hindered amine for stabilizing organic materials, in particular against oxidative, thermal and/or actinic degradation.

New stabilizer compositions and a new method for the stabilization of plastics in particular are thus proposed, which exhibit high efficacy, environmental friendliness and a favorable cost structure.

Surprisingly, a good stabilizing effect can be achieved with combinations of hindered amines and inorganic sulfites, and the hindered amine can be partially replaced by inexpensive sulfites.

In particular, the stabilizer composition is suitable for stabilizing plastics, coatings, lubricants, hydraulic oils, engine oils, turbine oils, transmission oils, metalworking fluids, chemicals or monomers.

In another preferred embodiment, the plastics are selected from the group consisting of virgin plastics, plastic recyclates, and mixtures or combinations thereof.

The at least one sulfite is preferably an inorganic sulfite, an inorganic disulfite or an inorganic hydrogen sulfite, preferably of a mono-, di-, tri- or tetravalent metal, the metal preferably being an alkali metal, an alkaline earth metal, aluminum and/or zinc, particularly preferably a sulfite selected from the group consisting of sodium sulfite, potassium sulfite, lithium sulfite, calcium sulfite, magnesium sulfite, aluminum sulfite, zinc sulfite and mixtures and combinations thereof, the sulfite used being particularly in its form free of water of crystallization.

Thiosulfate is in particular a thiosulfate of a monovalent, divalent, trivalent or tetravalent metal, the metal preferably being an alkali metal, an alkaline earth metal, aluminum and/or zinc, particularly preferably sodium thiosulfate, the thiosulfate being used in particular in its form free of water of crystallization.

Sterically hindered amines according to the present invention are heterocyclic amines having at least one alkyl, cycloalkyl or aryl group adjacent to the respective amine group. Preferred heterocyclic amines are derivatives based on piperidine, piperazine, piperazine-one or piperazine-dione, in particular the hindered amines have 2,2′,6,6′-tetramethylpiperidine units.

Preferably, the at least one polymeric or oligomeric hindered amine has a number-average molecular weight of >1000 g/mol, in particular the at least one polymeric or oligomeric hindered amine is selected from the group consisting of the following compounds

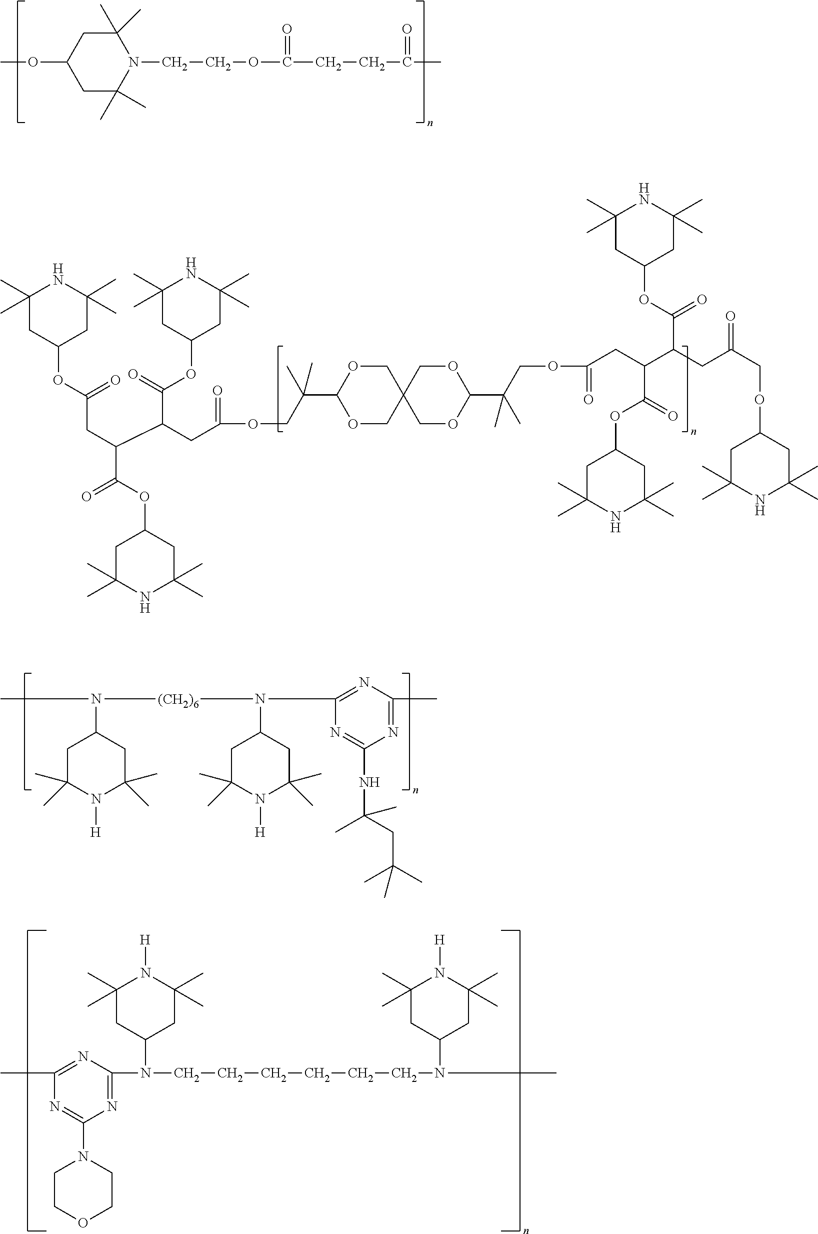

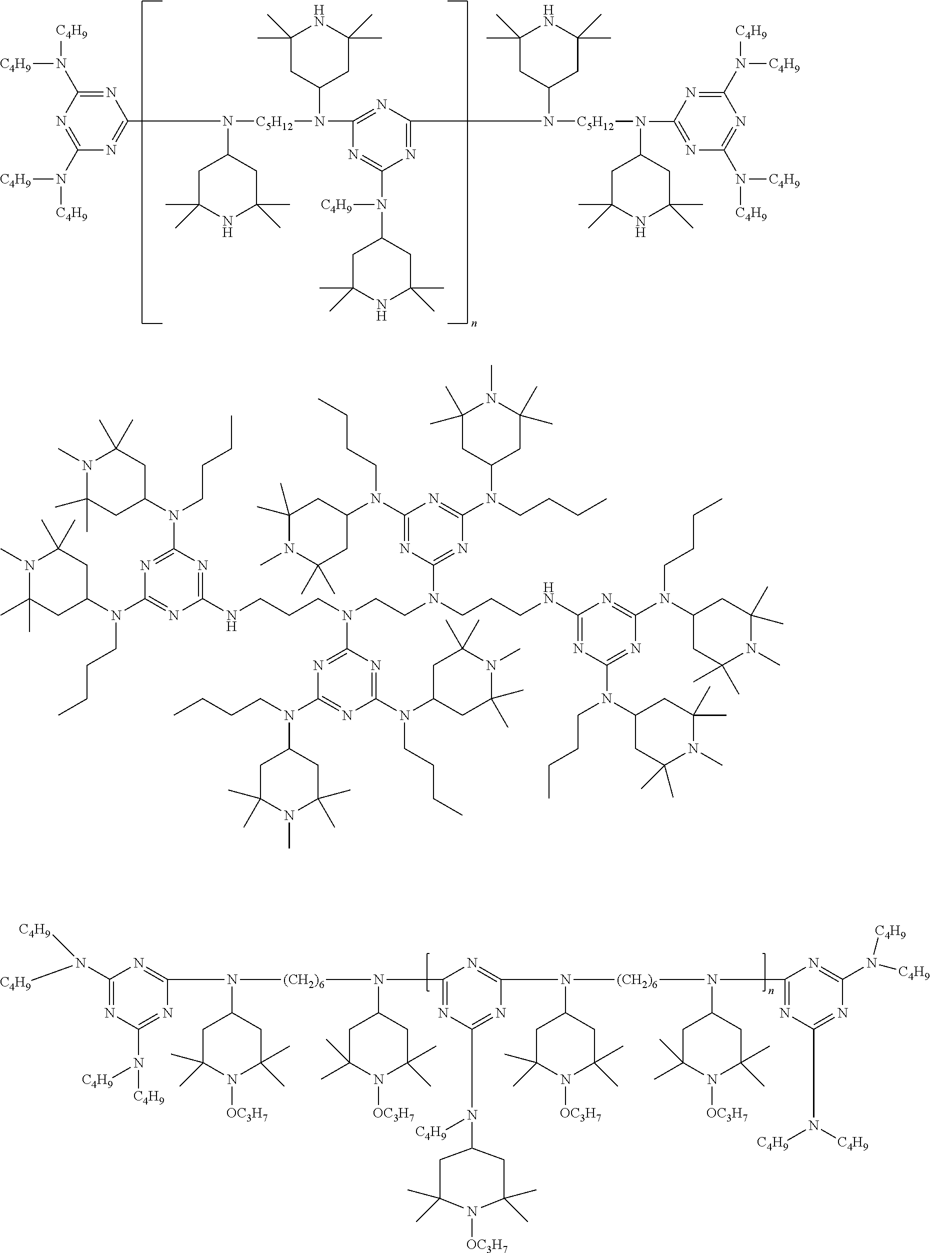

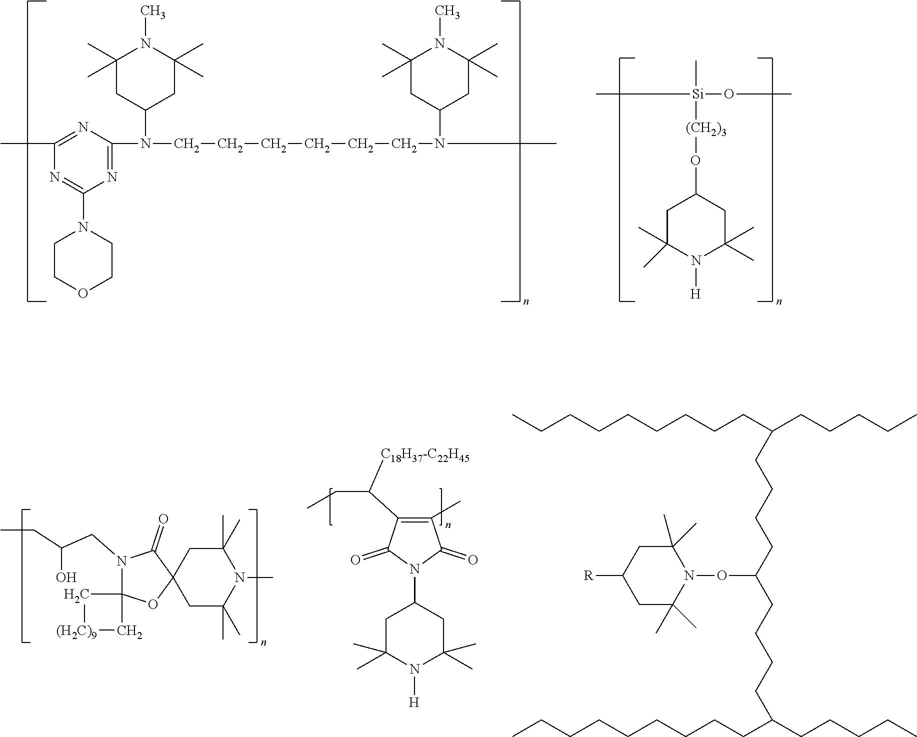

wherein n in each case means an integer of 2-100, preferably 3-20, particularly preferably 3-10, and

R means —O—C(O)-alkyl and in particular R means —O—C(O)—C₁₅H₃₁ or —O—C(O)—C₁₇H₃₅, wherein, in the case of an N—H group, this can be replaced at each occurrence independently by an N-alkyl group, such as N-methyl or N-octyl, an N-alkoxy group, such as N-methoxy or N-octyloxy, a cycloalkyl group, such as N-cyclohexyloxy and the N-(2-hydroxy-2-methylpropoxy) group, and mixtures and combinations thereof.

It is further preferred that the totality of the at least one sulfite and/or thiosulfate and the totality of the at least one polymeric or oligomeric hindered amine is used in a weight ratio of 1:99 to 99:1, preferably 20:80 to 80:20, further preferably from 30:70 to 70:30, particularly preferably from 40:60 to 60:40.

Preferably, the stabilizer composition is suitable for stabilizing plastics, wherein the plastic is in particular selected from the group consisting of
a) polymers of olefins or diolefins, such as polyethylene (LDPE, LLDPE, VLDPE, ULDPE, MDPE, HDPE, UHMWPE), metallocene-PE (m-PE), polypropylene, polyisobutylene, poly-4-methyl-pentene-1, polybutadiene, polyisoprene, such as natural rubber (NR), polycyclooctene, polyalkylene-carbon monoxide copolymers, as well as copolymers in the form of random or block structures, such as polypropylene-polyethylene (EP), EPM or EPDM with. for example, 5-ethylidene-2-norbornene as comonomer, ethylene-vinyl acetate (EVA), ethylene acrylic ester, such as ethylene-butyl acrylate, ethylene-acrylic acid and their salts (ionomers), as well as terpolymers such as ethylene-acrylic acid-glycidyl (meth)acrylate, graft polymers such as polypropylene-graft-maleic anhydride, polypropylene-graft-acrylic acid, polyethylene-graft-acrylic acid, polyethylene-polybutyl acrylate-graft-maleic anhydride as well as blends such as LDPE/LLDPE or also long-chain branched polypropylene copolymers produced with alpha-olefins as comonomers, for example with 1-butene, 1-hexene, 1-octene or 1-octadecene,
b) polystyrene, polymethylstyrene, poly-alpha-methylstyrene, polyvinylnaphthalene, polyvinylbiphenyl, polyvinyltoluene, styrene-butadiene (SB), styrene-butadiene-styrene (SBS), styrene-ethylene-butylene-styrene (SEBS), styrene-ethylene-propylene-styrene, styrene isoprene, styrene-isoprene-styrene (SIS), styrene-butadiene-acrylonitrile (ABS), styrene-acrylonitrile (SAN), styrene-acrylonitrile-acrylate (ASA), styrene-ethylene, styrene-maleic anhydride polymers including corresponding graft copolymers such as styrene on butadiene, maleic anhydride on SBS or SEBS, as well as graft copolymers of methyl methacrylate, styrene butadiene and ABS (MABS), as well as hydrogenated polystyrene derivatives such as polyvinylcyclohexane,
c) halogen-comprising polymers such as polyvinyl chloride (PVC), polychloroprene and polyvinylidene chloride (PVDC), copolymers of vinyl chloride and vinylidene chloride or of vinyl chloride and vinyl acetate, chlorinated polyethylene, polyvinylidene fluoride, epichlorohydrin homo and copolymers in particular with ethylene oxide (ECO),
d) polymers of unsaturated esters such as polyacrylates and polymethacrylates such as polymethyl methacrylate (PMMA), polybutyl acrylate, polylauryl acrylate; polystearyl acrylate; polyglycidyl acrylate, polyglycidyl methacrylate, polyacrylonitrile, polyacrylamides, copolymers such as polyacrylonitrile-polyalkyl acrylate,
e) polymers of unsaturated alcohols and derivatives, such as polyvinyl alcohol, polyvinyl acetate, polyvinyl butyral, polyallyl phthalate, polyallyl melamine,
f) polyacetals, such as polyoxymethylene (POM) or copolymers with, for example, butanal, polyphenylene oxides and blends with polystyrene or polyamides,
g) polymers of cyclic ethers, such as polyethylene glycol, polypropylene glycol, polyethylene oxide, polypropylene oxide, polytetrahydrofuran,
h) polyphenylene oxides and blends thereof with polystyrene and/or polyimides,
i) polyurethanes, from hydroxy-terminated polyethers or polyesters and aromatic or aliphatic isocyanates, such as 2,4- or 2,6-toluene diisocyanate or methylene diphenyl diisocyanate, in particular also linear polyurethanes (TPU), polyureas,
j) polyamides such as polyamide-6, 6.6, 6.10, 4.6, 4.10, 6.12, 10.10, 10.12, 12.12, polyamide 11, polyamide 12 as well as (partly) aromatic polyamides, such as polyphthalamides, for example produced from terephthalic acid and/or isophthalic acid and aliphatic diamines, such as hexamethylenediamine or m-xylylenediamine or from aliphatic dicarboxylic acids such as adipic acid or sebacic acid and aromatic diamines such as 1,4- or 1,3-diaminobenzene, blends of different polyamides such as PA-6 and PA 6.6 or blends of polyamides and polyolefins such as PA/PP,
k) polyimides, polyamideimides, polyetherimides, polyesterimides, poly(ether)ketones, polysulfones, polyethersulfones, polyarylsulfones, polyphenylene sulfides, polybenzimidazoles, polyhydantoins,
l) polyesters of aliphatic or aromatic dicarboxylic acids and diols or of hydroxy-carboxylic acids, such as polyethylene terephthalate (PET), polybutylene terephthalate (PBT), polypropylene terephthalate (PTI), polyethylene naphthylate (PEN), poly-1,4-dimethylolcyclohexane terephthalate, polyhydroxybenzoate, polyhydroxynaphthalate, polylactic acid (PLA), polyhydroxybutyrate (PHB), polyhydroxyvalerate (PHV), polyethylene succinate, polytetramethylene succinate, polycaprolactone,
m) polycarbonates, polyester carbonates, as well as blends such as PC/ABS, PC/PBT, PC/PET/PBT, PC/PA,
n) cellulose derivatives such as cellulose nitrate, cellulose acetate, cellulose propionate, cellulose butyrate,
o) epoxy resins consisting of di- or polyfunctional epoxy compounds in combination with, for example, hardeners based on amines, anhydrides, dicyandiamide, mercaptans, isocyanates or catalytically acting hardeners,
p) phenolic resins such as phenol-formaldehyde resins, urea-formaldehyde resins, melamine-formaldehyde resins,
q) unsaturated polyester resins from unsaturated dicarboxylic acids and diols with vinyl compounds, for example styrene, alkyd resins, allyl resins,
r) silicones, for example based on dimethylsiloxanes, methyl-phenyl-siloxanes or diphenylsiloxanes, for example vinyl-group-terminated,
s) and mixtures, combinations or blends of two or more of the aforementioned polymers.

If the polymers specified under a) to r) are copolymers, they can be in the form of random, block or tapered structures.

Furthermore, the mentioned polymers can be present in the form of linear, branched, star-shaped or hyper-branched structures.

If the polymers specified under a) to r) are stereoregular polymers, they can be in the form of isotactic, stereotactic, but also atactic forms or as stereoblock copolymers.

Furthermore, the polymers specified under a) to r) can have both amorphous and (partially) crystalline morphologies.

If necessary, the polyolefins mentioned under a) can also be cross-linked, for example cross-linked polyethylene, which is then called X-PE.

Furthermore, the present compounds can be used to stabilize rubbers and elastomers. These can be natural rubber (NR) or synthetic rubber materials.

Plastic recyclates, in particular thermoplastic recyclates, are also preferred as plastics.

Particularly preferred is the thermoplastic recyclate selected from the group consisting of polymers of olefins or diolefins, such as polyethylene, in particular LDPE, LLDPE, VLDPE, ULDPE, MDPE, HDPE and UHMWPE, metallocene-PE (m-PE), polypropylene, polyisobutylene, poly-4-methyl-pentene-1, polybutadiene, polyisoprene, polycyclooctene, polyalkylene-carbon monoxide copolymers, as well as corresponding copolymers in the form of random or block structures, such as polypropylene-polyethylene (EP), EPM or EPDM, ethylene-vinyl acetate (EVA), ethylene-acrylic esters such as ethylene-butyl acrylate, ethylene-acrylic acid-glycidyl acrylate, and corresponding graft polymers, such as polypropylene-g-maleic anhydride, polypropylene-g-acrylic acid and polyethylene-g-acrylic acid.

Very particularly preferably, the one thermoplastic resin is a polyolefin recyclate. For example, the thermoplastic recyclate can be polypropylene, in particular a polypropylene recyclate homopolymer or copolymer, or polyethylene, in particular a polyethylene recyclate, for example HDPE, LDPE, LLDPE or mixtures thereof.

In addition, additives can be used that are selected from the group consisting of primary and/or secondary antioxidants, UV absorbers, light stabilizers, metal deactivators, filler deactivators, antiozonants, nucleating agents, antinucleating agents, impact modifiers, plasticizers, lubricants, rheology modifiers, thixotropic agents, chain extenders, processing aids, demolding aids, flame retardants, pigments, dyes, optical brighteners, antimicrobial agents, antistatic agents, slip agents, antiblocking agents, coupling agents, crosslinking agents, anti-crosslinking agents, hydrophilizing agents, hydrophobicizing agents, adhesion promoters, dispersing agents, compatibilizers, oxygen scavengers, acid scavengers, blowing agents, degradation additives, defoaming agents, odor scavengers, marking agents, antifogging agents, fillers and reinforcing agents.

In a preferred embodiment, the compositions comprise in particular phosphites or phosphonites, fillers or acid scavengers.

Suitable phenolic antioxidants are, for example:
alkylated monophenols, such as 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, linear or branched nonylphenols such as 2,6-dinonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof;
alkylthiomethylphenols, such as 2,4-dioctylthiomethyl-6-tert-butylphenol, 2,4-dioctylthiomethyl-6-methylphenol, 2,4-dioctylthiomethyl-6-ethylphenol, 2,6-didodecylthiomethyl-4-nonylphenol;
hydroquinones and alkylated hydroquinones, such as 2,6-di-tert-butyl-4-methyoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxylphenyl)adipate;
tocopherols, such as α-, β-, γ-, δ-tocopherol and mixtures of these (vitamin E);
hydroxylated thiodiphenyl ethers, such as 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide;
alkylidene bisphenols, such as 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol, 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol bis[3,3-bis(3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methylphenyl]terephthalate, 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra(5-tert-butyl-4-hydroxy-2-methylphenyl)pentane;
O-, N- and S-benzyl compounds such as 3,5,3′,5′-tetra-tert-butyl-4,4′-dihydroxy dibenzyl ether, octadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate;
hydroxybenzylated malonates, such as dioctadecyl-2,2-bis(3,5-di-tert-butyl-2-hydroxybenzyl)malonate, dioctadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate;
aromatic hydroxybenzyl compounds, such as 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol;
triazine compounds, such as 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxphenylethyl)-1,3,5-triazine, 1,3,5-tris(3,5-di-tert-butyl-4-hydroyphenylpropionyl)hexahydro-1,3,5-triazine, 1,3,5-tris(3,5-dicyclohexyl-4-hydroxybenzyl)isocyanurate;
benzyl phosphonates, such as dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethyl ester of 3,5-di-tert-butyl-4-hydroxybenzylphosphonic acid;
acylaminophenols, such as 4-hydroxylauranilide, 4-hydroxystearanilide, octyl N-(3,5-di-tert-butyl-4-hydroxyphenyl)carbamate;
esters of β-(3,5-di-tert-butyl-4-hydroxyphenyl)propionic acid with mono- or polyvalent alcohols, for example methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;
esters of β-(5-tert-butyl-4-hydroxy-3-methylphenyl)propionic acid with mono- or polyvalent alcohols, for example methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octan, 3,9-bis[2-{3-(3-tert-butyl-4-hydroxy-5-methylphenyl)propionyloxy}-1,1-dimethylethyl]-2,4,8,10-tetraoxaspiro[5.5]undecane;
esters of β-(3,5-dicyclohexyl-4-hydroxyphenyl)propionic acid with mono- or polyvalent alcohols, for example methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;

esters of (3,5-di-tert-butyl-4-hydroxyphenyl)acetic acid with mono- or polyvalent alcohols, for example methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;
amides of β-(3,5-di-tert-butyl-4-hydroxyphenyl)propionic acid such as N,N′-bis(3,5-di-tert-butyl-4-hydroxyphenylpropionyl)hexamethylene diamide, N,N′-bis(3,5-di-tert-butyl-4-hydroxyphenylpropionyl)hexamethylene diamide, N,N′-bis(3,5-di-tert-butyl-4-hydroxyphenylpropionyl)hexamethylene diamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, distributed by Uniroyal);
ascorbic acid (vitamin C).

Particularly preferred phenolic antioxidants are the following structures:

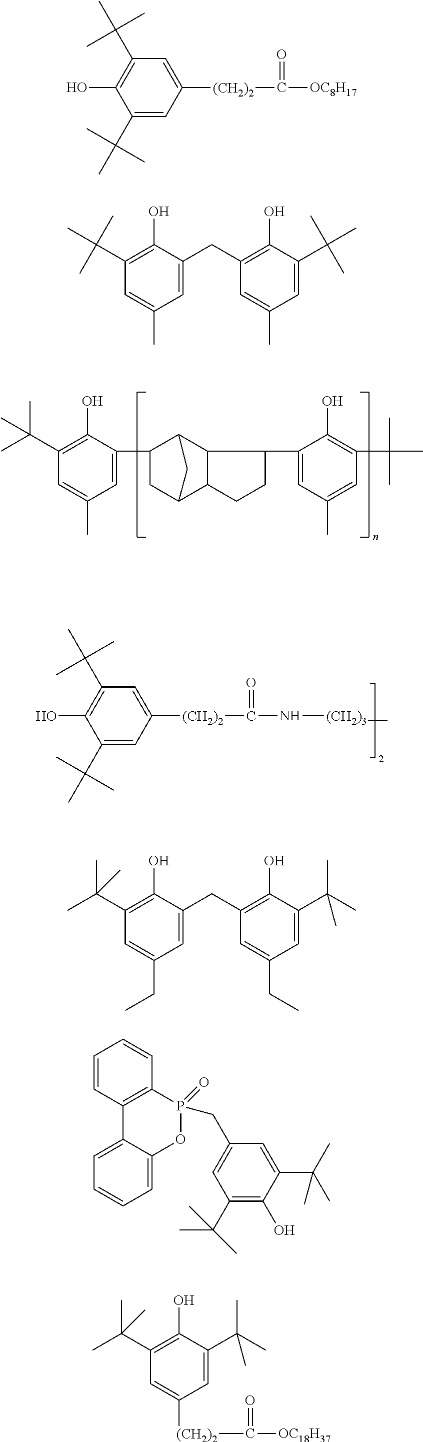

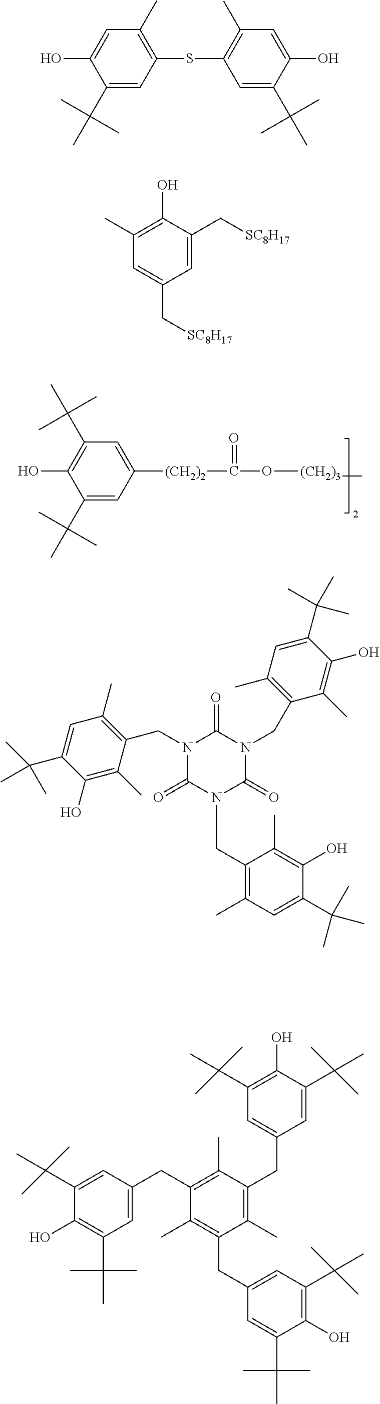

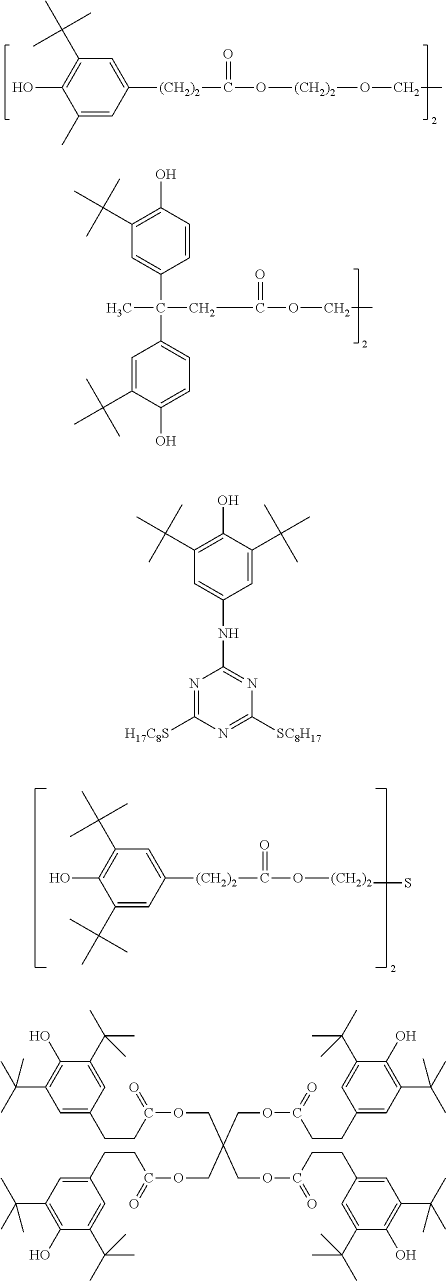

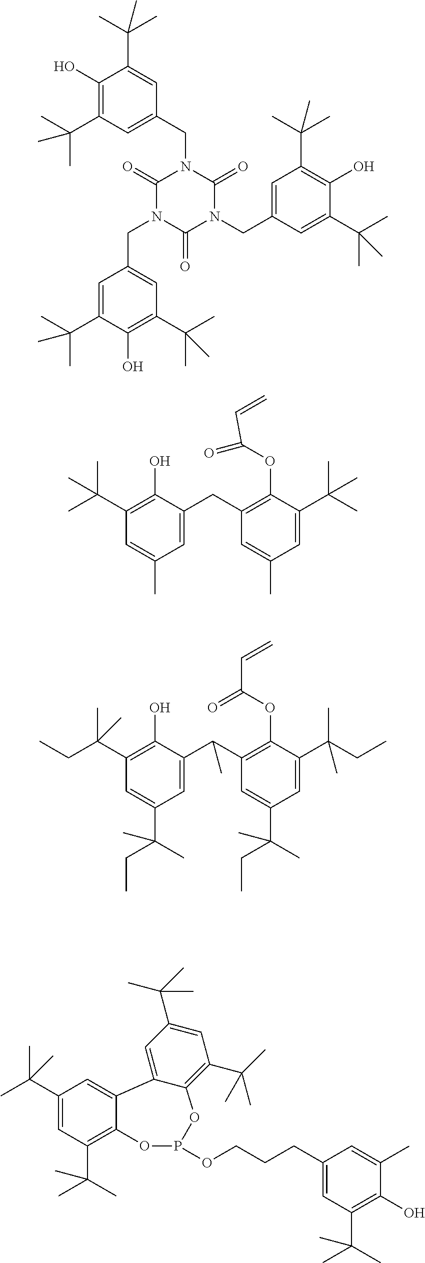

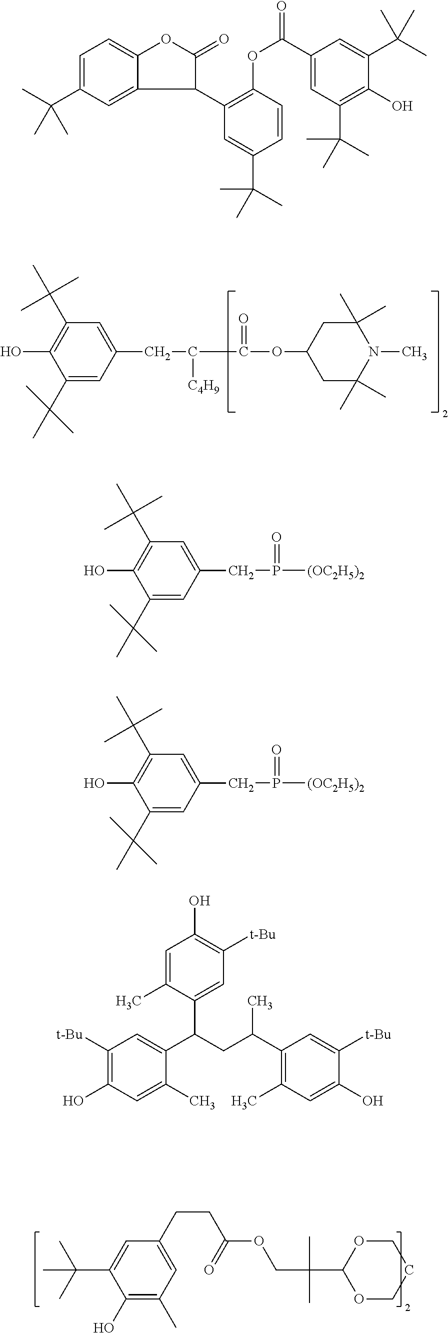

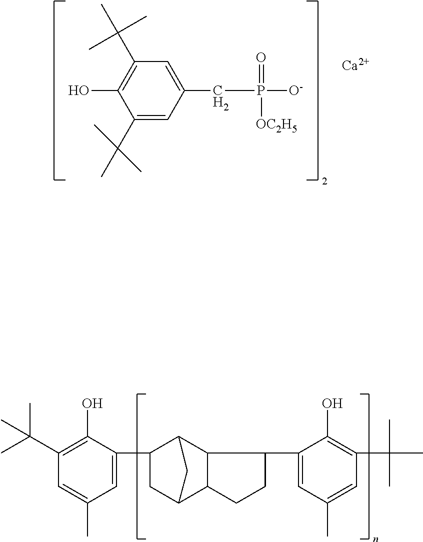

wherein, in the aforementioned compounds, n is an integer and is between 2 and 10.

Further preferred phenolic antioxidants are phenolic antioxidants based on renewable raw materials such as α-, β-, γ-, δ-tocopherol and mixtures thereof (vitamin E), tocotrienols, tocomonoenols, ubiquinol, hydroxytyrosol, flavonoids and flavonols such as chrysin, quercitin, hesperidin, neohesperidin, naringin, morin, kaempferol, fisetin, datiscetin, luteolin, apigenin, taxifolin, isoflavones such as genistein, genistin, daidzein, daidzin, formononetin, anthocyanins, such as delphinidin and malvidin, curcumin, carnosolic acid, carnosol, rosmarinic acid, tannin and resveratrol as well as carotenoids with alcoholic groups, such as beta-cryptoxanthin, lutein, zeaxanthin or astaxanthin.

Preferred fillers are calcium carbonate, silicates, talc, mica, kaolin, metal oxides and metal hydroxides, carbon black, graphite, wood flour or fibers of natural products such as cellulose. Other suitable fillers are hydrotalcites or zeolites or layered silicates such as montmorillonite, bentonite, beidelite, mica, hectorite, saponite, vermiculite, ledikite, magadite, illite, kaolinite, wollastonite, attapulgite.

Suitable secondary antioxidants are in particular phosphites or phosphonites such as triphenylphosphite, diphenylalkylphosphites, phenyldialkylphosphites, tri(nonylphenyl)phosphite, trilaurylphosphites, trioctadecylphosphite, distearylpentaerythritol diphosphite, tris-(2,4-di-tert-butylphenyl)phosphite, diisodecylpentaerythritol diphosphite, bis(2,4-di-tert-butylphenyl)pentaerythritol diphosphite, bis(2,4-di-cumylphenyl)pentaerythritol diphosphite, bis(2,6-di-tert-butyl-4-methylphenyl)pentaerythritol diphosphite, diisodecyloxypentaerythritol diphosphite, bis(2,4-di-tert-butyl-6-methylphenyl)pentaerythritol diphosphite, bis(2,4,6-tris(tert-butylphenyl)pentaerythritol diphosphite, tristearyl sorbitol triphosphite, tetrakis(2,4-di-tert-butylphenyl)-4,4′-biphenylenediphosphonite, 6-isooctyloxy-2,4,8,10-tetra-tert-butyl-12H-dibenz[d,g]-1,3,2-dioxaphosphocine, bis(2,4-di-tert-butyl-6-methylphenyl)methylphosphite, bis(2,4-di-tert-butyl-6-methylphenyl)ethylphosphite, 6-fluoro-2,4,8,10-tetra-tert-butyl-12-methyl-dibenz[d,g]-1,3,2-dioxaphosphocine, 2,2′2″-nitrilo[triethyltris(3,3″,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl))phosphite, 5-butyl-5-ethyl-2-(2,4,6-tri-tert-butylphenoxy)-1,3,2-dioxaphosphirane.

Particularly preferred phosphites/phosphonites are:

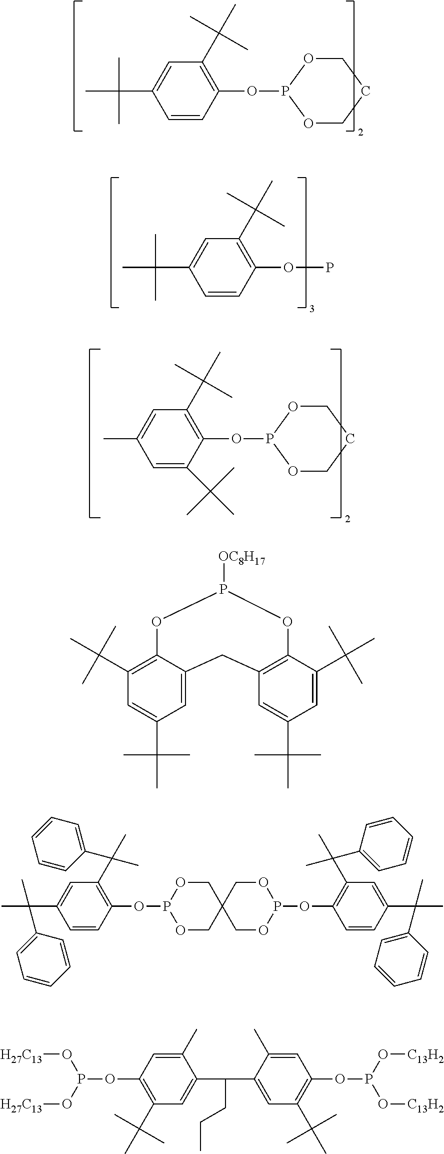

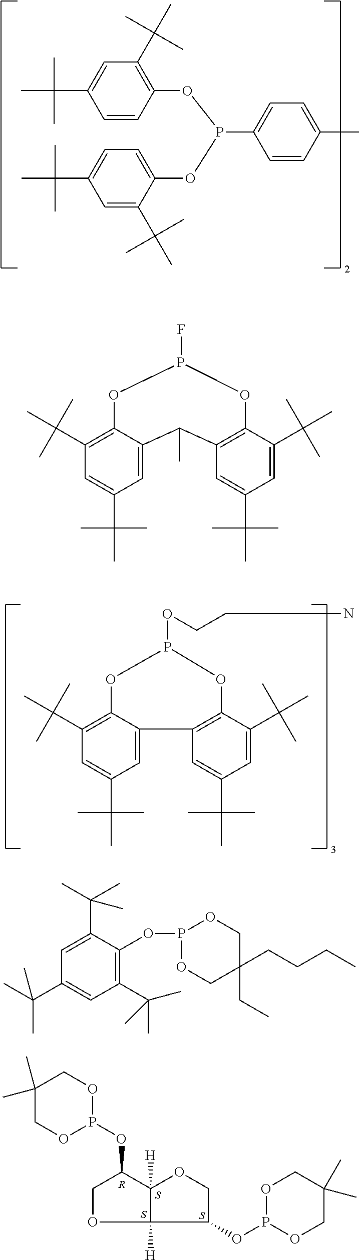

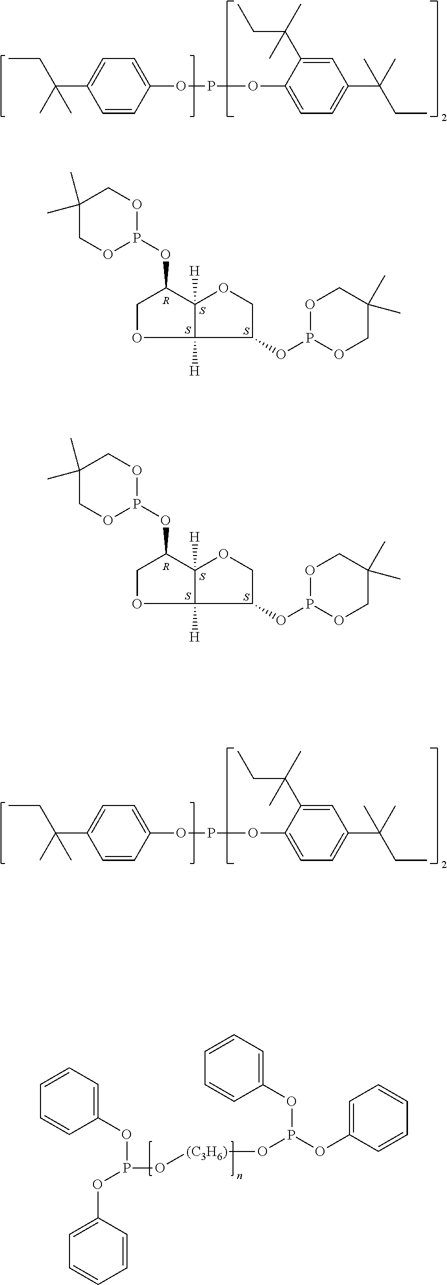

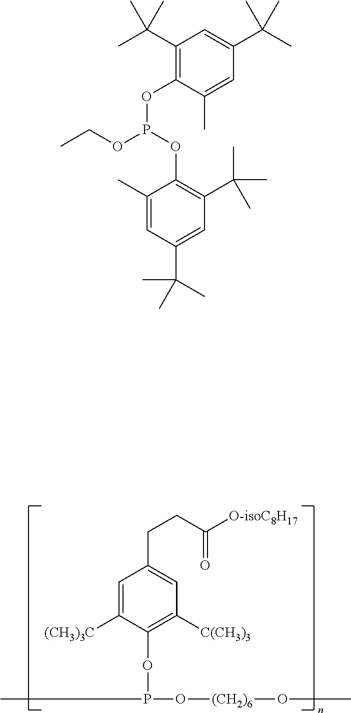

wherein n=3-100.

Very particularly preferably, the phosphite tris-(2,4-di-tert-butylphenyl)phosphite is used as a secondary antioxidant.

wherein n=3-100.

Very particularly preferably, the phosphite tris-(2,4-di-tert-butylphenyl)phosphite is used as a secondary antioxidant.

A preferred phosphonite is:

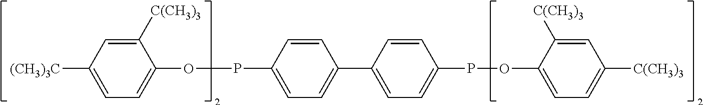

Suitable secondary antioxidants continue to be organo-sulfur compounds such as sulfides and disulfides such as distearyl thiodipropionate, dilauryl thiodipropionate; ditridecyl dithiopropionate, ditetradecyl thiodipropionate, 3-(dodecylthio)-, 1,1′-[2,2-bis[[3-(dodecylthio)-1-oxopropoxy]methyl]-1,3-propanediyl]propanoic acid ester. The following structures are preferred:

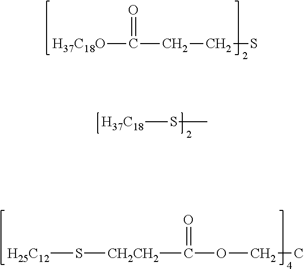

Suitable acid scavengers (“antiacids”) are salts of mono-, di-, tri- or tetravalent metals, preferably alkali metals, alkaline earth metals, aluminum or
zinc, especially formed with fatty acids, such as calcium stearate, magnesium stearate, zinc stearate, aluminum stearate, calcium laurate, calcium behenate, calcium lactate, calcium stearoyl-2-lactate. Other classes of suitable acid scavengers are hydrotalcites, in particular synthetic hydrotalcites based on aluminum, magnesium and zinc, hydrocalumites, zeolites, alkaline earth oxides, in particular calcium oxide and magnesium oxide as well as zinc oxide, alkaline earth carbonates, in particular calcium carbonate, magnesium carbonate and dolomite as well as hydroxides, in particular brucite (magnesium hydroxide).

Suitable co-stabilizers continue to be polyols, in particular alditols or cyclitols. Polyols are, for example, pentaerythritol, dipentaerythritol, tripentaerythritol, short-chain polyether polyols or short-chain polyester polyols, as well as hyper-branched polymers/oligomers or dendrimers with alcohol groups, for example:

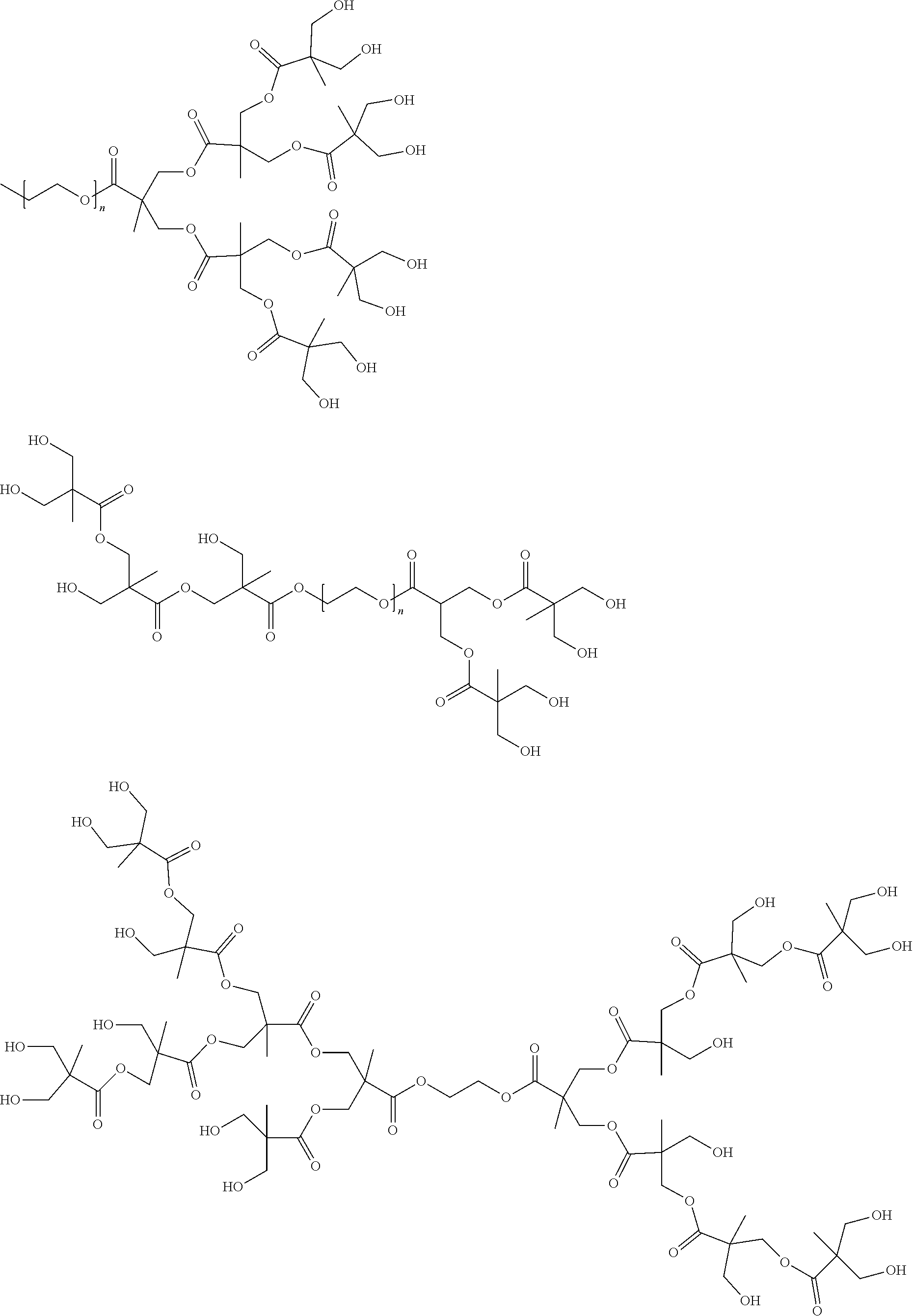

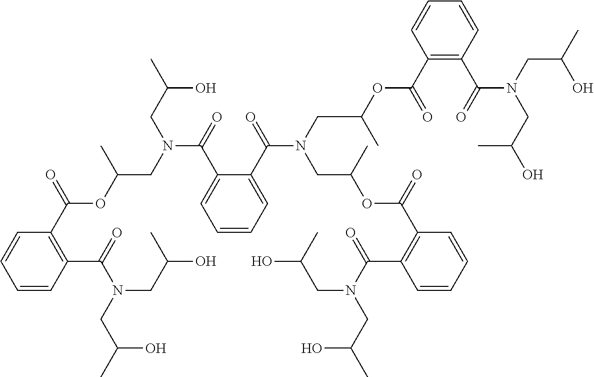 [SMILES: CC(O)CN(CC(C)O)C(=O)c1ccccc1C(=O)OC(C)CN(CC(C)O)C(=O)c1ccccc1C(=O)N(CC(C)OC(=O)c1ccccc1C(=O)N(CC(C)O)CC(C)O)CC(C)OC(=O)c1ccccc1C(=O)N(CC(C)O)CC(C)O]

Preferably, the at least one alditol is selected from the group consisting of threitol, erythritol, galactitol, mannitol, ribitol, sorbitol, xylitol, arabitol, isomaltol, lactitol, maltitol, altritol, iditol, maltotritol, and hydrogenated oligo- and polysaccharides having polyol end groups and mixtures thereof. Particularly preferred is the at least one preferred alditol selected from the group consisting of erythritol, mannitol, isomaltol, maltitol and mixtures thereof.

Examples of other suitable sugar alcohols are heptitols and octitols: meso-glycero-allo heptitol, D-glycero-D-altro heptitol, D-glycero-D-manno heptitol, meso-glycero-gulo heptitol, D-glycero-D-galacto heptitol (perseitol), D-glycero-D-gluco heptitol, L-glycero-D-gluco heptitol, D-erythro-L-galacto-octitol, D-threo-L-galacto-octitol.

In particular, the at least one cyclitol may be selected from the group consisting of inositol (myo, scyllo-, D-chiro-, L-chiro-, muco-, neo-, allo-, epi- and cis-inositol), 1,2,3,4-tetrahydroxycyclohexane, 1,2,3,4,5-pentahydroxycyclohexane, quercitol, viscumitol, bornesitol, conduritol, ononitol, pinitol, pinpollitol, quebrachitol, ciceritol, quinic acid, shikimic acid and valienol, with myo-inositol being preferred here.

Suitable light stabilizers are, for example, compounds based on 2-(2′-hydroxyphenyl)benzotriazoles, 2-hydroxybenzophenones, esters of benzoic acids, acrylates, oxamides and 2-(2-hydroxyphenyl)-1,3,5-triazines.

Suitable 2-(2′-hydroxyphenyl)benzotriazoles are, for example, 2-(2′-hydroxy-5′methylphenyl)benzotriazole, 2-(3′,5′-di-tert-butyl-2′-hydroxyphenyl)benzotriazole, 2-(5′-tert-butyl-2′-hydroxy-phenyl)benzotriazole, 2-(2′-hydroxy-5′-(1,1,3,3-tetramethylbutyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl-5-chlorobenzotriazole, 2-(3′-sec-butyl-5′-tert-butyl-2′-hydroxy-phenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazol-2-ylphenol]; the product of the transesterification of 2-[3′-tert-butyl-5′-(2-methoxycarbonylethyl)-2′-hydroxyphenyl]-2H-benzotriazole with polyethylene glycol 300; [R—CH₂CH₂—COO—CH₂CH₂—]—₂, where R=3′-tert-butyl-4′-hydroxy-5′-2H-benzotriazol-2-ylphenyl, 2-[2′-hydroxy-3′-(α,α-dimethylbenzyl)-5′-(1,1,3,3-tetramethylbutyl)phenyl]benzotriazole, 2-[2′-hydroxy-3′-(1,1,3,3-tetramethylbutyl)-5′-(α,α-dimethylbenzyl)phenyl]benzotriazole.

Suitable 2-hydroxybenzophenones are, for example, 4-hydroxy, 4-methoxy, 4-octyloxy, 4-decyloxy, 4-dodecyloxy, 4-benzyloxy, 4,2′,4′-trihydroxy and 2′-hydroxy-4,4′-dimethyoxy derivatives of 2-hydroxybenzophenones.

Suitable acrylates are, for example, ethyl-α-cyano-β,β-diphenyl acrylate, isooctyl-α-cyano-β,β-diphenyl acrylate, methyl-α-carbomethoxycinnamate, methyl-α-cyano-β-methyl-p-methoxycinnamate, butyl-α-cyano-β-methyl-p-methoxycinnamate, methyl-α-carbomethoxy-p-methoxycinnamate and N-(β-carbomethoxy-β-cyanovinyl)-2-methylindoline.

Suitable esters of benzoic acids are, for example, 4-tert-butylphenyl salicylate, phenyl salicylate, octylphenyl salicylate, dibenzoyl resorcinol, bis(4-tert-butylbenzoyl)resorcinol, benzoyl resorcinol, 2,4-di-tert-butylphenyl-3,5-di-tert-butyl-4-hydroxybenzoate, hexadecyl-3,5-di-tert-butyl-4-hydroxybenzoate, octadecyl-3,5-di-tert-butyl-4-hydroxybenzoate, 2-methyl-4,6-di-tert-butylphenyl-3,5-di-tert-butyl-4-hydroxybenzoate.

Suitable oxamides are, for example, 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and mixtures thereof with 2-ethoxy-2′-ethyl-5,4′-di-tert-butoxanilide, mixtures of o- and p-methoxy-disubstituted oxanilides and mixtures of o- and p-ethoxy-disubstituted oxanilides.

Suitable 2-(2-hydroxyphenyl)-1,3,5-triazines are, for example, 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[2-hydroxy-4-(2-hydroxy-3-butyloxypropoxy)-phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl-1,3,5-triazine.

Suitable metal deactivators are, for example, N,N′-diphenyloxamide, N-salicylal-N′-salicyloylhydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyldihydrazide, oxanilide, isophthaloyldihydrazide, sebacoylbisphenylhydrazide, N,N′-diacetyladipoyldihydrazide, N,N′-bis(salicyloyl)oxylyldihydrazide, N,N′-bis(salicyloyl)thiopropionyldihydrazide.

Particularly preferred as metal deactivators are:

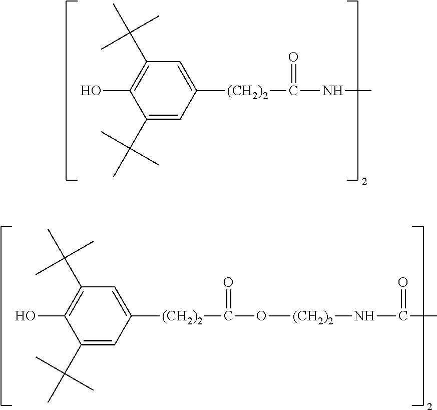

Suitable low-molecular hindered amines, which are, for example, 1,1-bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl)-n-butyl-3,5-di-tert-butyl-4-hydroxybenzylmalonate, the condensation product of 1-(2-hydroxyethyl)-2,2,6,6-tetramethyl-4-hydroxypiperidine and succinic acid, linear or cyclic condensation products of N,N′-bis(2,2,6,6-tetramethyl-4-piperidyl)hexamethylene diamine and 4-tert-octylamino-2,6-dichloro-1,3,5-triazine, tris(2,2,6,6-tetramethyl-4-piperidyl)nitrilotriacetate, tetrakis(2,2,6,6-tetramethyl-4-piperidyl)-1,2,3,4-butanetetracarboxylate, 1,1′-(1,2-ethanediyl)-bis(3,3,5,5-tetramethylpiperazinone), 4-benzoyl-2,2,6,6-tetramethylpiperidine, 4-stearyloxy-2,2,6,6-tetramethylpiperidine, linear or cyclic condensation products of N,N′-bis(2,2,6,6-tetramethyl-4-piperidyl)hexamethylene diamine and 4-morpholino-2,6-dichloro-1,3,5-triazine, the reaction product of 7,7,9,9-tetramethyl-2-cycloundecyl-1-oxa-3,8-diaza-4-oxospiro-[4,5]decane and epichlorohydrin.

Included in the above structures are in each case also the sterically hindered N—H, N-alkyl such as N-methyl or N-octyl, the N-alkoxy derivatives such as N-methoxy or N-octyloxy, the cycloalkyl derivatives such as N-cyclohexyloxy and the N-(2-hydroxy-2-methylpropoxy) analogues.

Preferred hindered amines furthermore have the following structures:

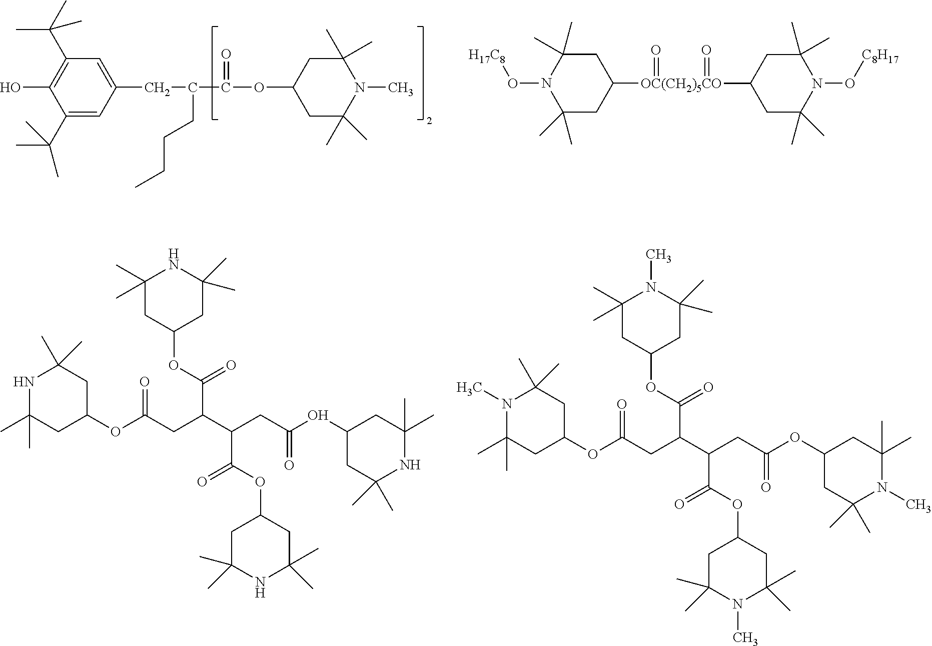

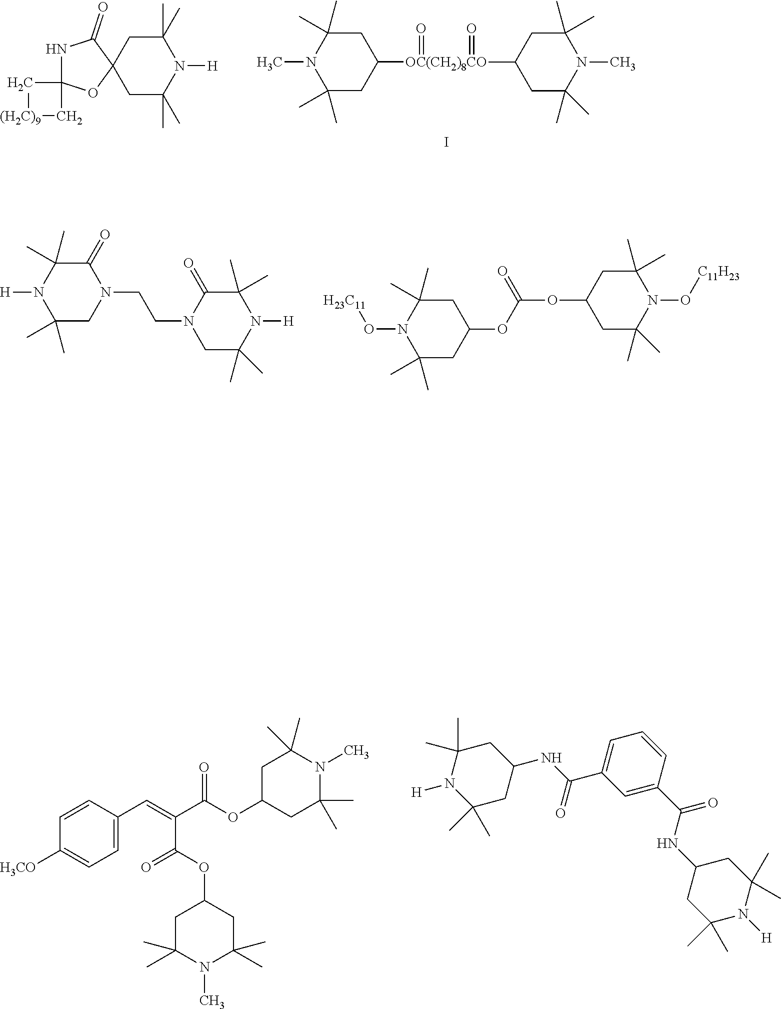

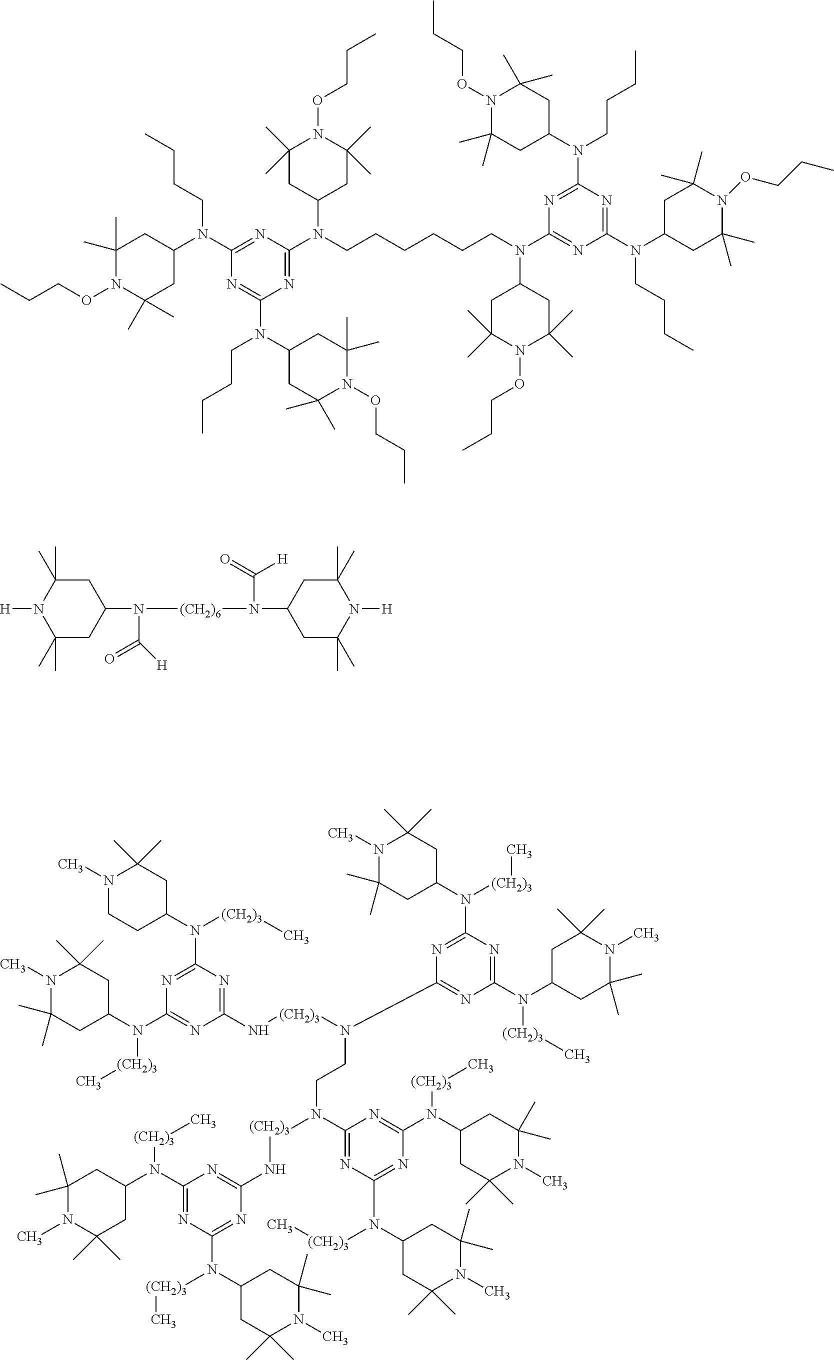

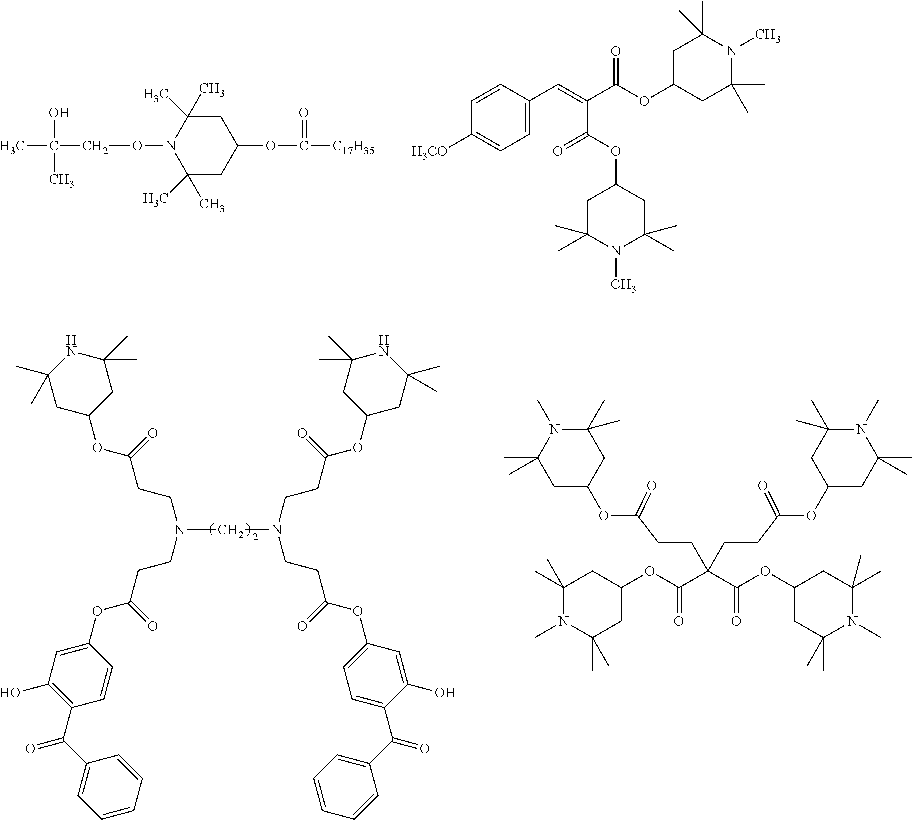

Suitable dispersants are, for example:

Polyacrylates, for example copolymers with long-chain side groups, polyacrylate block copolymers, alkylamides: for example N,N′-1,2-ethanediylbisoctadecanamide sorbitan esters, for example monostearyl sorbitan esters, titanates and zirconates, reactive copolymers with functional groups, for example polypropylene-co-acrylic acid, polypropylene-co-maleic anhydride, polyethylene-co-glycidyl methacrylate, polystyrene-alt-maleic anhydride polysiloxanes: for example dimethylsilanediol-ethylene oxide copolymer, polyphenylsiloxane copolymer, amphiphilic copolymers: for example polyethylene-block-polyethylene oxide, dendrimers, for example dendrimers comprising hydroxyl groups.

Suitable antinucleating agents are azine dyes such as nigrosine.

Suitable flame retardants are in particular
inorganic flame retardants such as Al(OH)3, Mg(OH)2, AlO(OH), MgCO3, phyllosilicates such as montmorillonite or sepiolite, unmodified or organically modified, double salts such as Mg—Al-silicates, POSS (Polyhedral Oligomeric Silsesquioxane) compounds, huntite, hydromagnesite or halloysite as well as Sb2O3, Sb2O5, MoO3, zinc stannate, zinc hydroxystannate,
nitrogenous flame retardants such as melamine, melem, melam, melon, melamine derivatives, melamine condensation products or melamine salts, benzoguanamine, polyisocyanurates, allantoin, phosphacenes, in particular melamine cyanurate, melamine phosphate, dimelamine phosphate, melamine pyrophosphate, melamine polyphosphate, melamine metal phosphates such as melamine aluminum phosphate, melamine zinc phosphate, melamine magnesium phosphate, and the corresponding pyrophosphates and polyphosphates, poly-[2,4-(piperazin-1,4-yl)-6-(morpholin-4-yl)-1,3,5-triazine], ammonium polyphosphate, melamine borate, melamine hydrobromide,
radical formers, such as alkoxyamines, hydroxylamine esters, azo compounds, triazene compounds, disulfides, polysulfides, thiols, thiuram sulfides, dithiocarbamates, mercaptobenzthiazoles sulfenamides, sulfenimides,
dicumyl or polycumyl, hydroxyimides and derivatives thereof, such as hydroxyimide esters or hydroxyimide ethers,
phosphorus-comprising flame retardants such as red phosphorus, phosphates such as resorcinol diphosphate, bisphenol A diphosphate and oligomers thereof, triphenyl phosphate, ethylenediamine diphosphate, phosphinates such as hypophosphorous acid salts and their derivatives such as alkyl phosphinate salts, for example diethyl phosphinate aluminum or diethyl phosphinate zinc or aluminum phosphinate, aluminum phosphite, aluminum phosphonate, phosphonate esters, oligomeric and polymeric derivatives of methane phosphonic acid, 9,10-dihydro-9-oxa-10-phosphorylphenanthrene-10-oxide (DOPO) and substituted compounds thereof,
halogen-comprising chlorine- and bromine-based flame retardants such as polybrominated diphenyl oxides, for example decabromodiphenyloxide, tris(3-bromo-2,2-bis(bromomethyl)propyl-phosphate, tris(tribromneopentyl)phosphate, tetrabromophthalic acid, 1,2-bis(tribromophenoxy)ethane, hexabromocyclododecane, brominated diphenylethane, tris-(2,3-dibromopropyl)isocyanurate, ethylene-bis(tetrabromophthalimide), tetrabromo-bisphenol A, brominated polystyrene, brominated polybutadiene or polystyrene-brominated polybutadiene copolymers, brominated polyphenylene ether, brominated epoxy resin, polypentabromobenzyl acrylate, optionally in combination with Sb2O3 and/or Sb2O5,
borates such as zinc borate or calcium borate, optionally on carrier material such as silica,
sulfur-comprising compounds such as elemental sulfur, disulfides and polysulfides, thiuram sulfide, dithiocarbamates, mercaptobenzothiazole and sulfenamides,
antidrip agents such as polytetrafluoroethylene,
silicon-comprising compounds such as polyphenylsiloxanes,
carbon modifications such as carbon nanotubes (CNTs), expanded graphite or graphene,
and combinations or mixtures thereof.

Suitable plasticizers are, for example, phthalic acid esters, adipic acid esters, esters of citric acid, esters of 1,2-cyclohexanedicarboxylic acid, trimellitic acid esters, isosorbide esters, phosphate esters, epoxides such as epoxidized soybean oil or aliphatic polyesters.

Suitable lubricants and processing aids are, for example, polyethylene waxes, polypropylene waxes, salts of fatty acids such as calcium stearate, zinc stearate or salts of montan waxes, amide waxes such as erucic acid amide or oleic acid amides, fluoropolymers, silicones or neoalkoxytitanates and zirconates.

Suitable pigments can be inorganic or organic in nature. Inorganic pigments are, for example, titanium dioxide, zinc oxide, zinc sulfide, iron oxide, ultramarine, carbon black; organic pigments are, for example, anthraquinones, anthanthrones, benzimidazolones, quinacridones, diketopyrrolopyrroles, dioxazines, indanthrones, isoindolinones, azo compounds, perylenes, phthalocyanines or pyranthrones. Other suitable pigments are metal-based effect pigments or metal oxide-based pearlescent pigments.

Suitable optical brighteners are, for example bisbenzoxazoles, phenyl coumarins or bis(styryl)biphenyls and in particular optical brighteners of formulas:

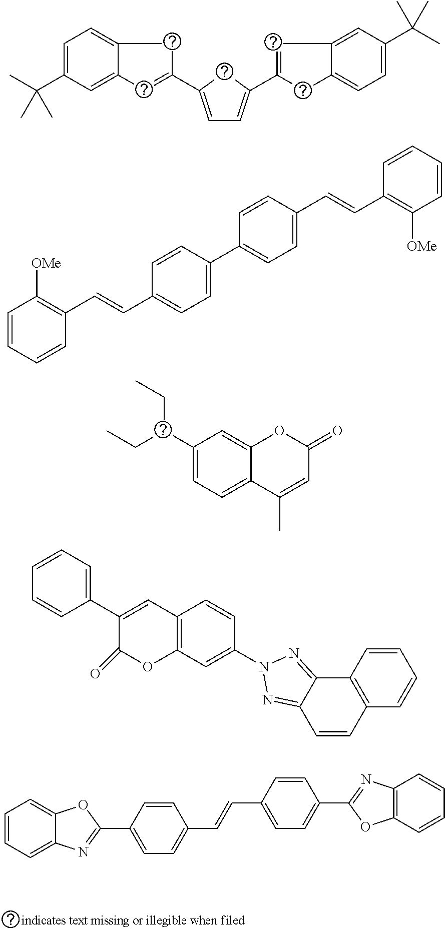

Suitable filler deactivators are, for example, polysiloxanes, polyacrylates, in particular block copolymers such as polymethacrylic acid-polyalkylene oxide or polyglycidyl(meth)acrylates and copolymers thereof, for example with styrene and epoxides for example of the following structures:

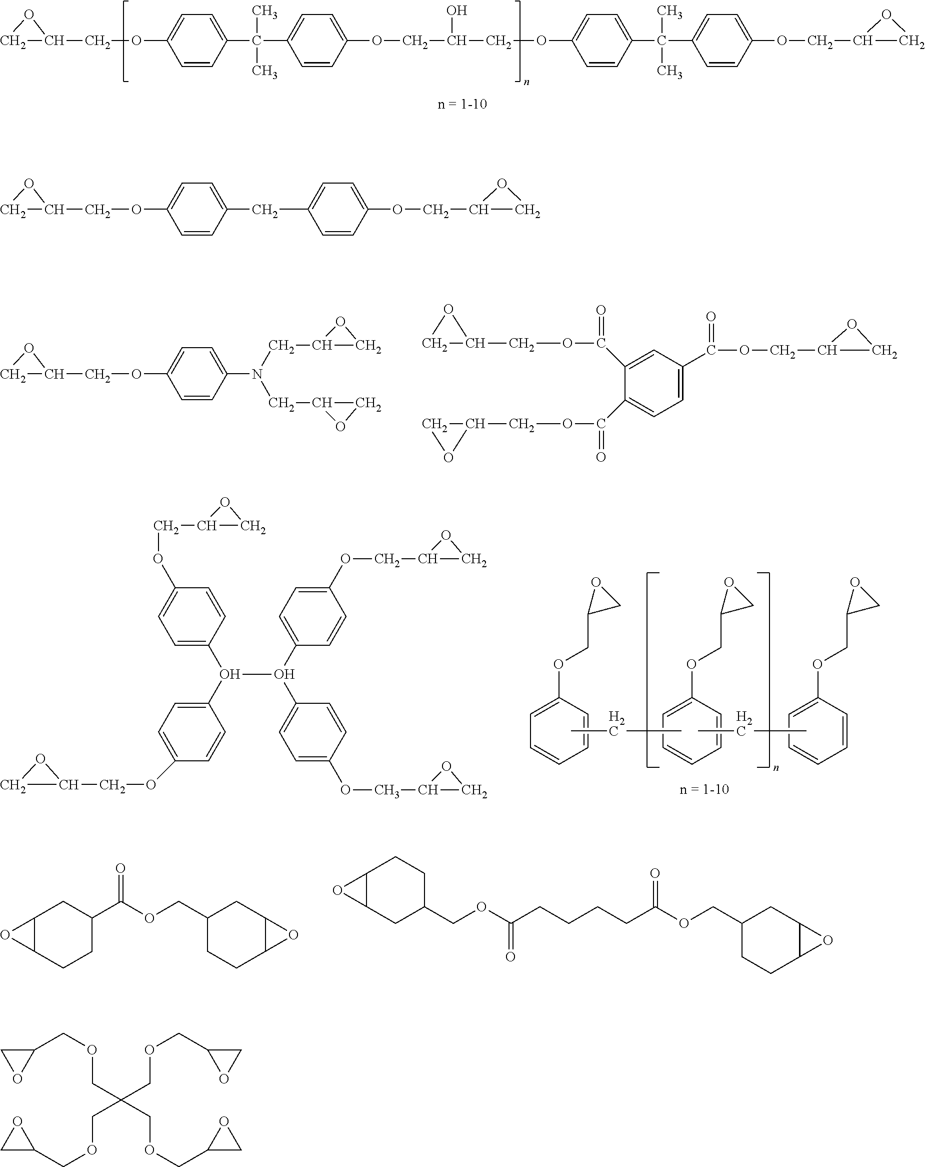

Furthermore, in a preferred embodiment, the present invention relates to a use of the stabilizer composition in combination with at least one additive, in particular at least one additive selected from the group consisting of primary antioxidants, secondary antioxidants other than phosphites and phosphonites, UV absorbers, light stabilizers, metal deactivators, filler deactivators, antiozonants, nucleating agents, antinucleating agents, impact modifiers, lubricants, rheology modifiers, thixotropic agents, chain extenders, processing aids, mold release aids, flame retardants, pigments, dyes, optical brighteners, antimicrobial agents, antistatic agents, slip agents, anti-blocking agents, coupling agents, cross-linking agents, anti-cross-linking agents, hydrophilizing agents, hydrophobizing agents, adhesion promoters, dispersants, compatibilizers, oxygen scavengers, acid scavengers, blowing agents, degradation additives, defoaming agents, odor scavengers, marking agents, antifogging agents, fillers and reinforcing agents and mixtures thereof.

The invention furthermore relates to a stabilizer composition for stabilizing organic materials, in particular against oxidative, thermal and/or actinic degradation, consisting of at least one sulfite and/or at least one thiosulfate in combination with at least one polymeric or oligomeric hindered amine.

According to a preferred embodiment, it is provided that the totality of the at least one sulfite and/or thiosulfate and the totality of the at least one polymeric or oligomeric hindered amine are present in a weight ratio of 1:99 to 99:1, preferably 20:80 to 80:20, further preferably from 30:70 to 70:30, particularly preferably from 40:60 to 60:40.

The present invention also relates to a masterbatch, comprising 10 to 90 wt. % of a stabilizer composition according to one of the two preceding claims, and 90 to 10 wt. % of a thermoplastic resin, in particular a plastic recyclate, a virgin plastic or a mixture thereof.

The present invention furthermore relates to a composition, in particular plastic composition, comprising or consisting of
A) a stabilizer composition according to the invention and
B) an organic material to be stabilized, in particular a plastic.

A preferred embodiment of the present composition provides that the composition comprises or consists of
(A) 0.01 to 10.00 wt. %, preferably 0.02 to 5.00 wt. %, particularly preferably 0.05 to 2.00 wt. % of the stabilizer composition,
(B) 85.00 to 99.98 wt. %, preferably 96 to 99.90 wt. %, of at least one plastic, and
(C) 0.01 to 5.00 wt. %, preferably 0.05 to 1.00 wt. % of at least one additive.

A further advantageous embodiment provides that, based on 100 parts by weight of components (A) to (C), up to 80 parts by weight, preferably 0.1 to 60 parts by weight, particularly preferably 1 to 50 parts by weight of at least one plasticizer, filler and/or reinforcing agent is comprised.

In addition, the present invention relates to a molding compound or a molded part, producible from a composition according to the invention, in particular in the form of foils or films, packaging, for example for foodstuffs or cosmetic products, detergents, cosmetics or adhesives; hollow bodies, in particular bottles, bags, screw-top cans; storage and transport containers, e.g. boxes, crates, barrels, buckets, automotive, railway, aircraft, ship and machine parts, such as bumpers, trim parts, fittings and functional parts, upholstery; construction applications such as profiles, construction foils, roofing membranes, cable ducts, house cladding, noise barriers, drainage channels, profiled boards, floor coverings, pallets; road and landscaping applications such as beacon bases, posts, barriers, geotextiles; electrical and electronic applications such as housing parts and accessories of televisions, computers, mobile phones, washing machines, dishwashers, coffee machines, drills, connectors, storage media; cable insulation;
parts from additive or generative manufacturing processes, such as fused layer modeling (FLM), layer laminate modeling (LLM), selective laser sintering (SLS) and other 3D printing processes; pipes for, for example, water, gas, sewage, irrigation, drainage pipes; hygiene articles such as nappies or as a component of disposable nappies, sanitary pads and tampons; furniture and textile applications, such as curtains and upholstery, worktops; foams, tapes, injection-molded parts, fibers, and other extrudates; household, leisure and sporting articles such as balls, tennis rackets, skis, flower pots, rain barrels, clothes hangers; agricultural applications such as greenhouse, mulch, tunnel or perforated films, plant pots, membranes such as geomembranes;
pharmaceutical and crop protection applications such as encapsulation of active ingredients and biologically active substances; as well as sutures, bandages, orthotics and prosthetics.

Furthermore, the present invention relates to a method for oxidative, thermal and/or actinic stabilization of a thermoplastic resin, in particular against oxidative, thermal and/or actinic degradation, by adding, supplementing or incorporating at least one stabilizer composition according to the invention to or into the plastic.

Preferably, the additive combination according to the invention, which may be present as a powder, liquid, oil, compacted, on a carrier material, as granules, solution or flakes, is mixed with the polymer to be stabilized, and the polymer matrix is transferred into the melt and then cooled. Alternatively, it is also possible to introduce one or more additives into a polymer melt in a molten state.

In the event that further components are added to the polymer composition, these may be added to the polymers separately, in the form of liquids, powders, granules or compacted products, or together with the additive composition according to the invention as described above.

The incorporation of the additive composition described above and, if necessary, the additional additives into the plastic is carried out by conventional processing methods, preferably by mixers, kneaders or extruders. Preferred processing machines are extruders, such as single-screw extruders, twin-screw extruders, planetary roller extruders, ring extruders, and co-kneaders, which are preferably equipped with vacuum degassing. The processing can take place here under air or, if necessary, under inert gas conditions.

Another aspect of the present invention relates to the use of the composition according to the invention described above for the production of foils or films, packaging, for example for foodstuffs or cosmetic products, detergents, cosmetics or adhesives; hollow bodies, in particular bottles, bags, screw-top cans; storage and transport containers, e.g. boxes, crates, barrels, buckets, automotive, railway, aircraft, ship and machine parts, such as bumpers, trim parts, fittings and functional parts, upholstery; construction applications such as profiles, construction foils, roofing membranes, cable ducts, house cladding, noise barriers, drainage channels, profiled boards, floor coverings, pallets; road and landscaping applications such as beacon bases, posts, barriers, geotextiles; electrical and electronic applications such as housing parts and accessories of televisions, computers, mobile phones, washing machines, dishwashers, coffee machines, drills, connectors, storage media; cable insulation; parts from additive or generative manufacturing processes such as fused layer modeling (FLM), layer laminate modeling (LLM), selective laser sintering (SLS) and other 3D printing processes; pipes for, for example, water, gas, sewage, irrigation, drainage pipes; hygiene articles such as nappies or as a component of disposable nappies, sanitary pads and tampons; furniture and textile applications, such as curtains and upholstery, worktops; foams, tapes, injection-molded parts, fibers, and other extrudates; household, leisure and sporting articles such as balls, tennis rackets, skis, flower pots, rain barrels, clothes hangers; agricultural applications such as greenhouse, mulch, tunnel or perforated films, plant pots, membranes such as geomembranes; pharmaceutical and crop protection applications, such as for the encapsulation of active ingredients and biologically active substances; as well as sutures, bandages, orthotics and prosthetics.

The present invention is described in more detail with reference to the following exemplary embodiments, without limiting the present invention to the specific examples presented.

### EXEMPLARY EMBODIMENTS

To test the effect of the stabilizer composition according to the invention, a polylactide (PLA) (Luminy L175, supplier: Total Corbion) together with the ingredients listed in Table 1, and a post-consumer polypropylene recyclate from battery case ground material (supplier: BSB Braubach) together with the additives listed in Table 2 were circulated in the melt at 210° C. in a twin-screw micro extruder (Micro 5 cc, manufacturer DSM) in continuous mode at 200 rpm for 30 minutes. After 30 minutes, the force absorption is measured. The force is a measure of the toughness of the melt and thus of the molecular weight of the polymer. The higher the remaining force, the lower the degradation of the polymer. The mean value from 2 tests is given in each case.

TABLE 1
Stabilization of PLA

| | Additives | Residual force after 30 minutes [%] |
|---|---|---|
| Comparative example 1 | Without additive | 42 |
| Comparative example 2 | 0.2% sodium sulfite | 54 |
| Comparative example 3 | 0.2% polymeric hindered amine* | 78 |
| Example 1 according to the invention | 0.1% sodium sulfite + 0.1% polymeric hindered amine* | 78 |

*Sabostab 119 of formula:

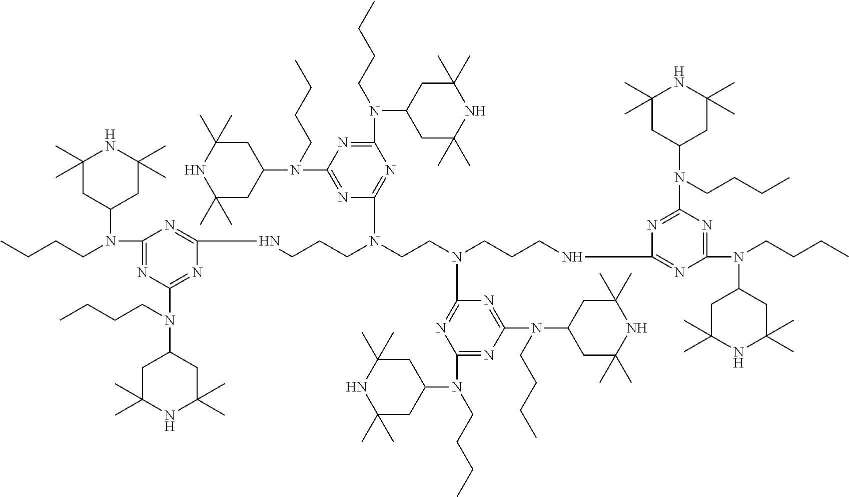 [SMILES: CCCCN(c1nc(NCCCN(CCN(CCCNc2nc(N(CCCC)C3CC(C)(C)NC(C)(C)C3)nc(N(CCCC)C3CC(C)(C)NC(C)(C)C3)n2)c2nc(N(CCCC)C3CC(C)(C)NC(C)(C)C3)nc(N(CCCC)C3CC(C)(C)NC(C)(C)C3)n2)c2nc(N(CCCC)C3CC(C)(C)NC(C)(C)C3)nc(N(CCCC)C3CC(C)(C)NC(C)(C)C3)n2)nc(N(CCCC)C2CC(C)(C)NC(C)(C)C2)n1)C1CC(C)(C)NC(C)(C)C1]

TABLE 1
Stabilization of PP battery case recyclate

| | Post-stabilization | Residual force after 10/20/30 minutes [%] |
|---|---|---|
| Comparative example 1 | Without additive | 72/40/21 |
| Comparative example 2 | 0.1% sodium sulfite | 74/44/24 |
| Example 1 according to the invention | 0.1% sodium sulfite + 0.1% polymeric hindered NOR* | 79/53/29 |

** Tinuvin NOR 371 of formula:

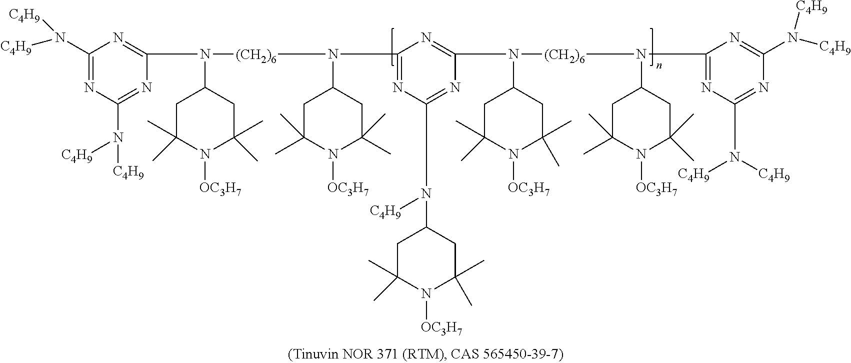

The combinations according to the invention lead to a very good stabilizing effect alongside an advantageous cost structure.

Surprisingly, a good stabilizing effect can be achieved with combinations of hindered amines and inorganic sulfites, and the hindered amine can be partially replaced by inexpensive sulfites.

New stabilizer compositions and a new method for stabilizing plastics in particular, which are highly effective, environmentally friendly and have a favorable cost structure, are provided.

1-21. (canceled)

22. A method of stabilizing an organic material comprising combining the organic material with at least one stabilizer composition,
said at least one stabilizer composition comprises at least one sulfite and/or at least one thiosulfate in combination with at least one polymeric or oligomeric hindered amine.

23. The method of claim 22, wherein the organic material is stabilized against oxidative thermal and/or actinic degradation.

24. The method according to claim 22, wherein the organic material is selected from the group consisting of plastics, coatings, lubricants, hydraulic oils, engine oils, turbine oils, transmission oils, metalworking fluids, chemicals, and monomers.

25. The method according to claim 24, wherein the plastics are selected from the group consisting of virgin plastics, plastic recyclates, mixtures and combinations thereof.

26. The method according to claim 22, wherein
the at least one sulfite is an inorganic sulfite, an inorganic disulfite, or an inorganic hydrogen sulfite, and/or
the at least one thiosulfate is a thiosulfate of a monovalent, divalent, trivalent or tetravalent metal.

27. The method according to claim 22, wherein the at least one sulfite is selected from the group consisting of sodium sulfite, potassium sulfite, lithium sulfite, calcium sulfite, magnesium sulfite, aluminum sulfite, and zinc sulfite.

28. The method according to claim 22, wherein the at least one polymeric or oligomeric hindered amine has a number-average molecular weight of >1000 g/mol.

29. The method according to claim 22, wherein the at least one polymeric or oligomeric hindered amine is: 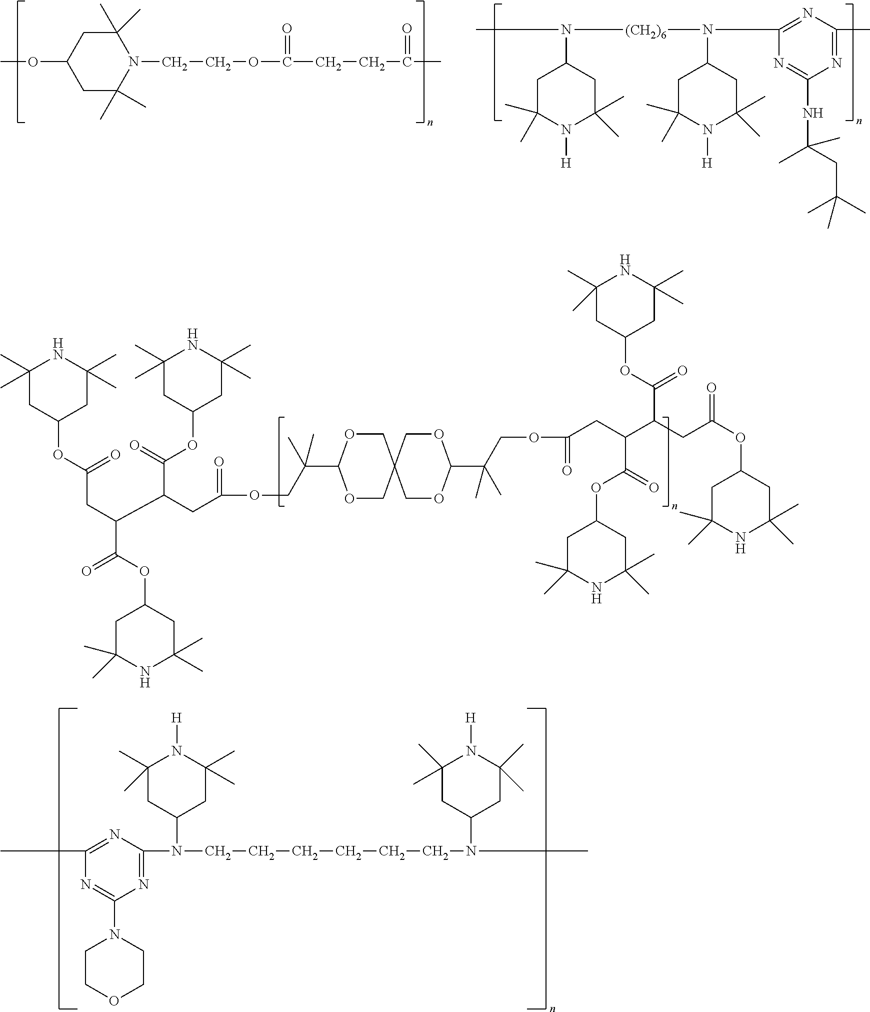 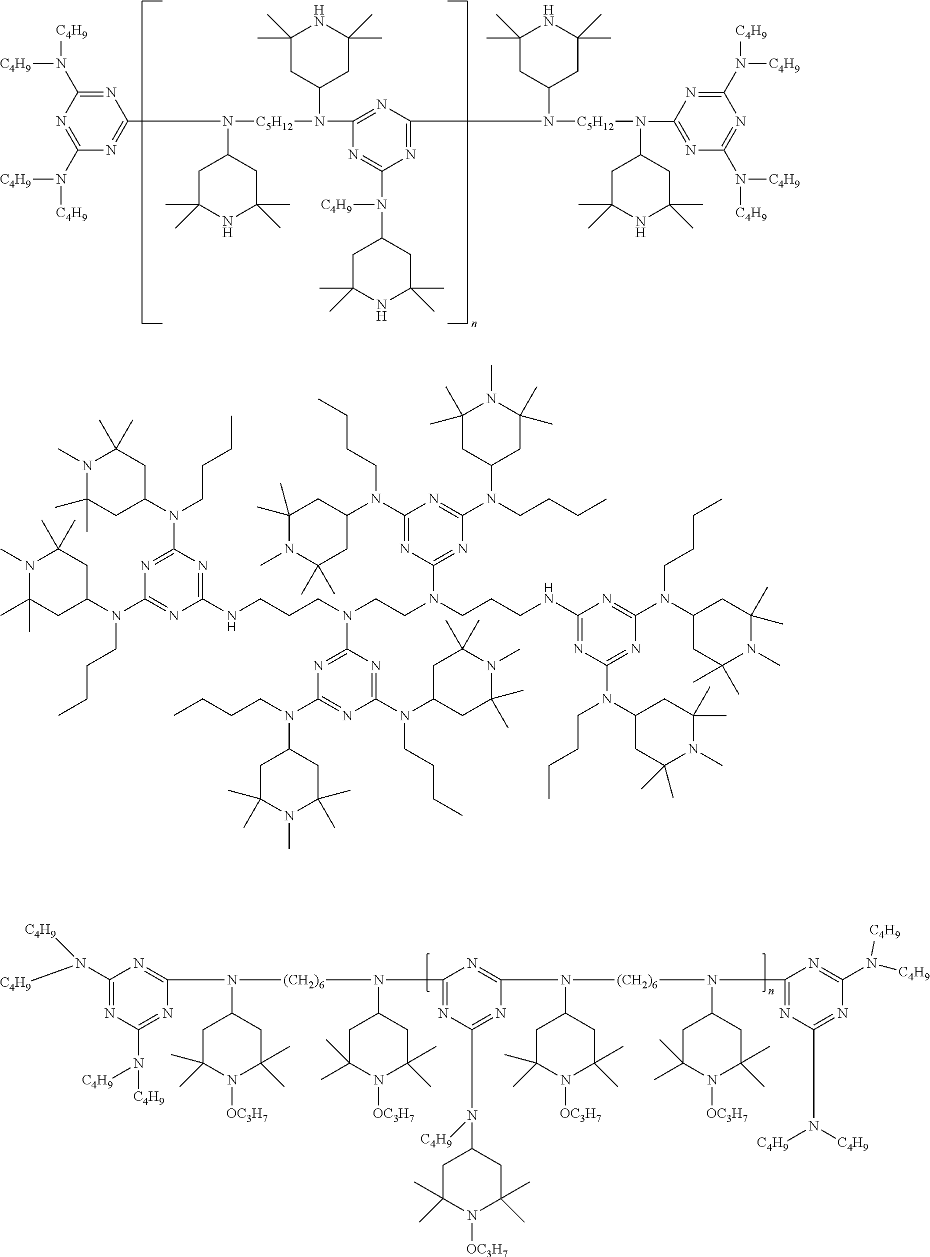 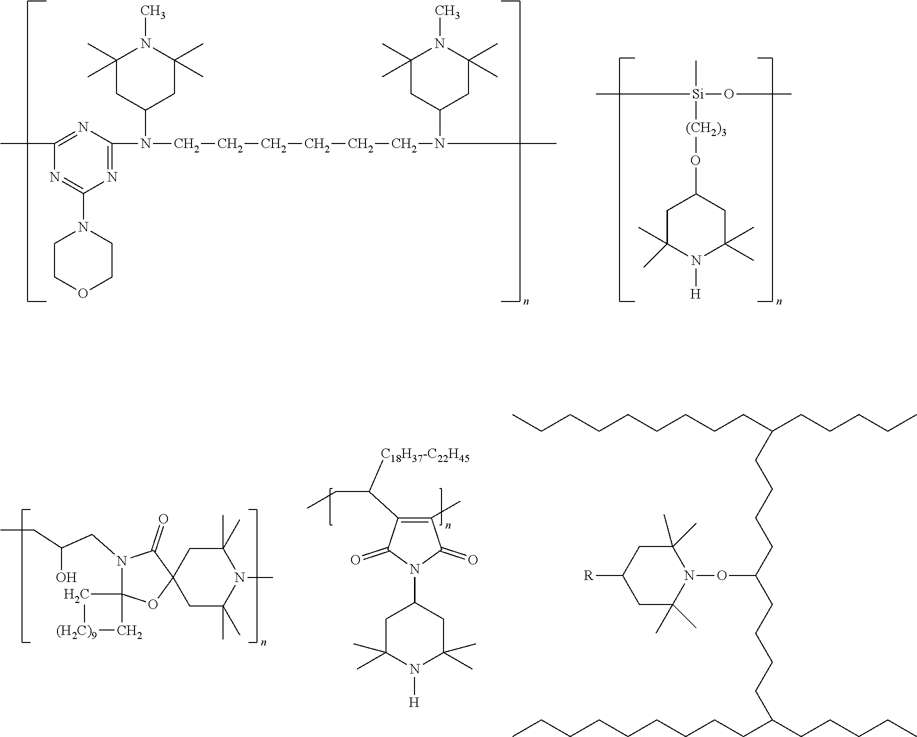
wherein n in each case means an integer of 2-100, and
R is —O—C(O)—C₁₅H₃₁ or —O—C(O)—C₁₇H₃₅,
wherein, in the case of an N—H group, it can be replaced at each occurrence independently by an N-alkyl group, an N-alkoxy group, a cycloalkyl group, an N-cyclohexyloxy group, or an N-(2-hydroxy-2-methylpropoxy) group.

30. The method according to claim 22, wherein the stabilizer composition, in relation to the organic materials to be stabilized, is present in a weight ratio of 0.01 to 10.00 wt. %.

31. The method according to claim 22, wherein
the totality of the at least one sulfite and/or thiosulfate and the totality of the at least one polymeric or oligomeric hindered amine are present in a weight ratio of 1:99 to 99:1.

32. The method according to claim 22, wherein the plastic is selected from the group consisting of
(a) polymers of olefins or diolefins, copolymers thereof in the form of random or block structures, ethylene-vinyl acetate (EVA), ethylene acrylic esters, graft polymers, polyolefin blends, long-chain branched polypropylene copolymers produced with alpha-olefins as comonomers, polystyrene, polymethylstyrene, poly-alpha-methyl styrene, polyvinylnaphthalene, polyvinylbiphenyl, polyvinyltoluene, styrene-butadiene (SB), styrene-butadiene-styrene (SBS), styrene-ethylene-butylene-styrene (SEBS), styrene-ethylene-propylene-styrene, styrene isoprene, styrene-isoprene-styrene (SIS), styrene-butadiene-acrylonitrile (ABS), styrene-acrylonitrile (SAN), styrene-acrylonitrile-acrylate (ASA), styrene-ethylene, styrene-maleic anhydride polymers, graft copolymers of methyl methacrylate, styrene butadiene and ABS (MABS), hydrogenated polystyrene derivatives, or polyvinylcyclohexane,
(b) halogen-comprising polymers,
(c) polymers of unsaturated esters, polyacrylonitrile, polyacrylamides, or polyacrylonitrile-polyalkyl acrylate,
(d) polymers of unsaturated alcohols, polyvinyl acetate, polyvinyl butyral, polyallyl phthalate, polyallyl melamine, polyacetals, polyoxymethylene (POM), copolymers of POM with butanal, polyphenylene oxides and blends with polystyrene or polyamides, or polymers of cyclic ethers,
(e) polyphenylene oxides and blends thereof with polystyrene and/or polyimides,
(f) polyurethanes made from hydroxy-terminated polyethers or polyesters and aromatic or aliphatic isocyanates, or polyureas,
(g) polyamides, polyimides, polyamideimides, polyetherimides, polyesterimides, poly(ether)ketones, polysulfones, polyethersulfones, polyarylsulfones, polyphenylene sulfides, polybenzimidazoles, or polyhydantoins,
(h) polyesters of aliphatic or aromatic dicarboxylic acids and diols or of hydroxy-carboxylic acids,
(i) polycarbonates, polyester carbonates, as well as blends such as PC/ABS, PC/PBT, PC/PET/PBT, PC/PA,
(j) cellulose derivatives,
(k) epoxy resins consisting of di- or polyfunctional epoxy compounds in combination with hardeners,
(l) phenolic resins,
(m) unsaturated polyester resins,
(n) silicones,
and mixtures, combinations or blends of two or more of the aforementioned polymers.

33. The method according to claim 22, wherein the stabilizer composition includes at least one additive.

34. The method according to claim 33, wherein the additive is selected from the group consisting of primary antioxidants, secondary antioxidants other than phosphites and phosphonites, UV absorbers, light stabilizers, metal deactivators, filler deactivators, antiozonants, nucleating agents, antinucleating agents, impact modifiers, lubricants, rheology modifiers, thixotropic agents, chain extenders, processing aids, mold release aids, flame retardants, pigments, dyes, optical brighteners, antimicrobial agents, antistatic agents, slip agents, anti-blocking agents, coupling agents, cross-linking agents, anti-cross-linking agents, hydrophilizing agents, hydrophobizing agents, adhesion promoters, dispersants, compatibilizers, oxygen scavengers, acid scavengers, blowing agents, degradation additives, defoaming agents, odor scavengers, marking agents, antifogging agents, fillers, reinforcing agents, and mixtures thereof.

35. A stabilizer composition for stabilizing organic materials consisting of
at least one sulfite and/or at least one thiosulfate in combination with
at least one polymeric or oligomeric hindered amine.

36. The stabilizer composition according to claim 35, wherein
the totality of the at least one sulfite and/or thiosulfate and
the totality of the at least one polymeric or oligomeric hindered amine
are present in a weight ratio of 1:99 to 99:1.

37. A masterbatch, comprising
10 to 90 wt. % of a stabilizer composition according to claim 36, and
90 to 10 wt. % of a thermoplastic resin.

38. A composition comprising a stabilizer composition according to claim 36 and an organic material to be stabilized.

39. The composition according to claim 38, which comprises 0.01 to 10.00 wt. % of the stabilizer composition, 85.00 to 99.98 wt. %, of at least one plastic, and
0.01 to 5.00 wt. % of at least one additive.

40. The composition according to claim 39, wherein the at least one additive is selected from the group consisting of primary antioxidants, secondary antioxidants other than phosphites and phosphonites, UV absorbers, light stabilizers, metal deactivators, filler deactivators, antiozonants, nucleating agents, antinucleating agents, impact modifiers, lubricants, rheology modifiers, thixotropic agents, chain extenders, processing aids, mold release aids, flame retardants, pigments, dyes, optical brighteners, antimicrobial agents, antistatic agents, slip agents, anti-blocking agents, coupling agents, cross-linking agents, anti-cross-linking agents, hydrophilizing agents, hydrophobizing agents, adhesion promoters, dispersants, compatibilizers, oxygen scavengers, acid scavengers, blowing agents, degradation additives, defoaming agents, odor scavengers, marking agents, antifogging agents, fillers, reinforcing agents, and mixtures thereof.

41. The composition according to claim 40, which includes, based on 100 parts by weight of total components, up to 80 parts by weight of at least one plasticizer, filler, and/or reinforcing agent.

42. The composition according to claim 40, wherein
(a) the phosphites or phosphonites are selected from the group consisting of the following compounds: 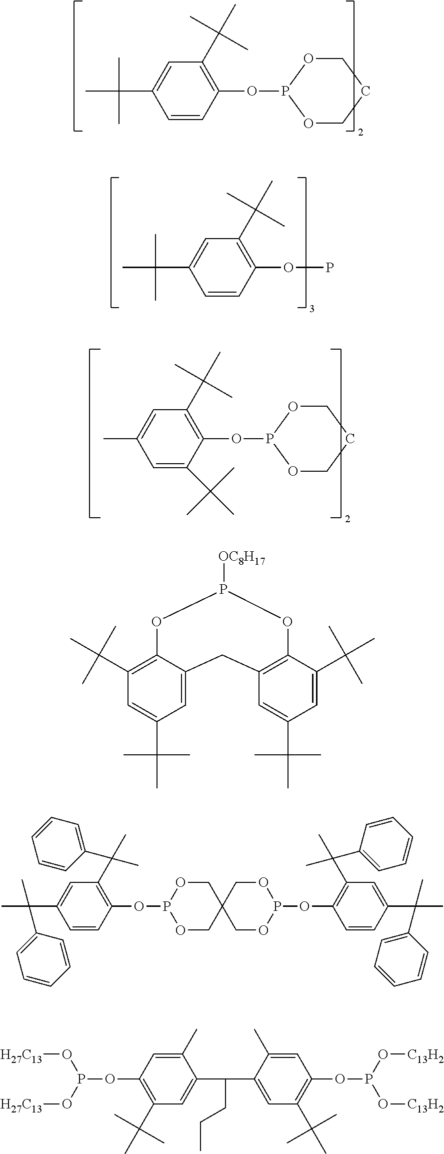 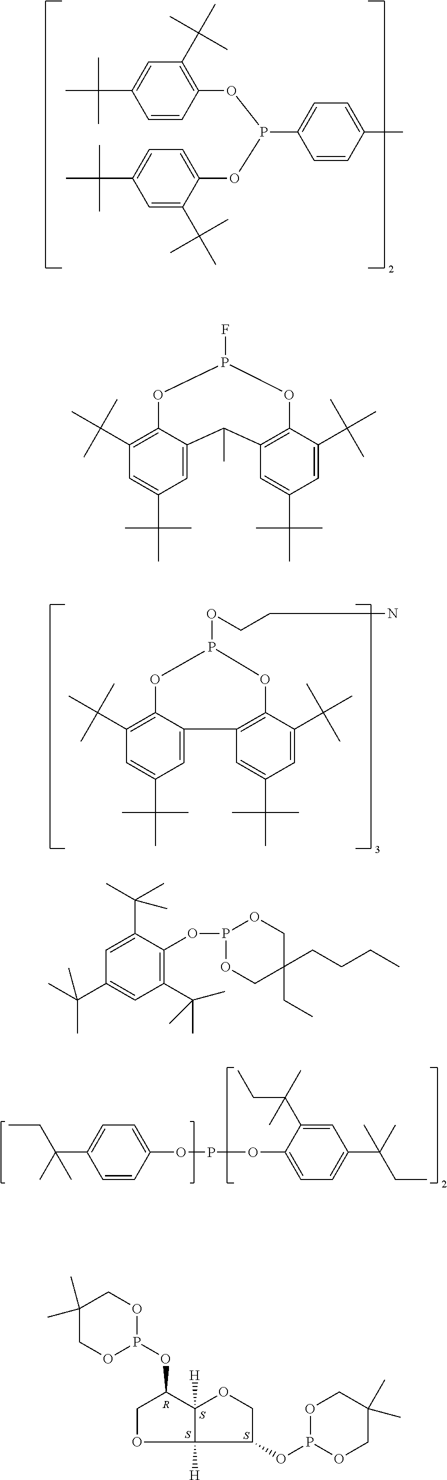 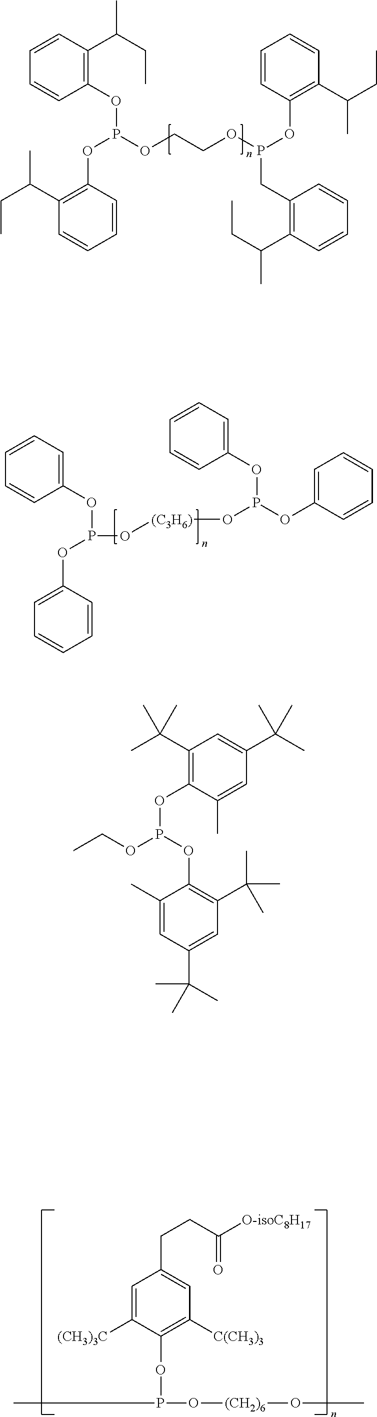
with n=3-100, 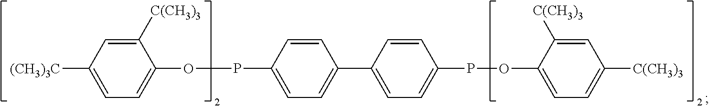
(b) the fillers and/or reinforcing agents are selected from the group consisting of calcium carbonate, silicates, talc, mica, kaolin, metal oxides metal hydroxides, carbon black, graphite, wood flour, fibers of natural products such as cellulose, glass fibers, carbon fibers, polyaramide fibers and other synthetic polymer fibers, hydrotalcites, zeolites and layered silicates, and
(c) the acid scavengers are selected from the group consisting of salts of mono-, di-, tri- or tetravalent metals.

43. A molding compound or molded part produced from a composition according to claim 39.

44. The molded part produced according to claim 43, which is/are:
foils or films,
packagings,
hollow bodies,
automotive, railway, aircraft, ship or machine parts,
parts for construction applications;
parts for road and landscaping applications;
parts for electrical and electronic applications;
cable insulation;
parts from additive or generative manufacturing processes;
pipes;
hygiene articles;
furniture and textile applications;
foams, tapes, injection-molded parts, fibers, and other extrudates;
household, leisure, and sporting articles;
articles for agricultural applications;
articles for pharmaceutical or crop protection applications; and
sutures, bandages, orthotics and/or prosthetics.
